(19) United States
(12) Patent Application Publication
(10) Pub. No.: US 2025/0148516 A1
(43) Pub. Date: May 8, 2025

(54) METHOD AND SYSTEM FOR PRODUCT DIMENSION NAVIGATION

(71) Applicant: LULULEMON ATHLETICA CANADA INC., Vancouver (CA)

(72) Inventors: Mirza Saquib SARWAR, Vancouver (CA); Janessa Lauren Sachiyo MURAO, Vancouver (CA)

(21) Appl. No.: 18/931,833

(22) Filed: Oct. 30, 2024

Related U.S. Application Data
(60) Provisional application No. 63/595,837, filed on Nov. 3, 2023.

(51) Int. Cl. G06Q 30/0601; G06F 3/01; G06F 3/0488

(52) U.S. Cl. CPC G06Q 30/0623; G06F 3/017; G06F 3/0488; G06Q 30/0643

(57) ABSTRACT

Embodiments described herein relate to visual display systems that selectively and automatically update product depictions. Embodiments described herein relate to systems and methods to providing product depictions based on two or more product dimensions, for receiving sensor data, evaluating a navigational gesture, providing and updating product depictions and output to the user through a device. The system generates digital instructions and output for an online web application, device hosted application, smart device, or similar system.

### REFERENCE TO RELATED APPLICATION

This application claims the benefit of and priority to U.S. Provisional Patent Application No. 63/595,837 entitled METHOD AND SYSTEM FOR PRODUCT DIMENSION NAVIGATION and filed on Nov. 3, 2023, the entire contents of which is hereby incorporated by reference.

### FIELD

Embodiments described herein relate to electrical computers, computer graphics processing, selective visual display systems, digital retail navigation, automated computer systems and machine learning systems and methods for prioritizing product depiction display, generating logical groupings and prioritizations, receiving a gesture using measurements from sensors, dynamic information retrieval, and changing the content (e.g. product depiction) provided or displayed based on the gesture.

### INTRODUCTION

Websites, software applications, and other digital tools can be used for navigating, understanding, buying and selling products. Websites, software applications, and other digital tools can provide users with product information, the ability to check the availability of products and purchase products. Embodiments described herein can provide an improved visual display system or product navigation system with multiple ways for users to understand products, aspects and features associated with products, and to interact with displayed product depictions in order to evaluate the purchase of a product and/or improve product sales. Embodiments described herein can involve selectively updating visual displays by changing product depictions provided or displayed based on gestures.

### SUMMARY

Embodiments described herein provide a computer implemented method and system for selectively updating a visual display and providing output instructions for product navigation in response to one or more user gestures.

In an aspect, embodiments described herein provide a computer implemented method for selectively updating a visual display and providing output instructions for product navigation in response to one or more user gestures. The method involves: receiving, using at least one hardware processor, a set of product data defining more than one product; wherein in the set of product data, a set of elements associated with the product provide, a product depiction associated with the product; two metadata values, wherein the first metadata value comprises one of a value associated with a product taxonomy, a product characteristic, a combination of the product taxonomy and the product characteristic associated with the product, and wherein the second metadata value comprises one of a value associated with a product taxonomy, a product characteristic, a combination of the product taxonomy and the product characteristic associated with the product; associating, using at least one hardware processor, the first metadata value associated with the product of a first category and a second metadata value associated with the product of a second category; categorizing, using at least one hardware processor, a first grouping of products, represented by product depictions, associated with the first category, and a second grouping of products, represented by product depictions, associated with the second category wherein the first grouping is associated with one or more sets of first axis logic associated with the first category and the second grouping is associated with one or more set of second axis logic associated with the second category; receiving, using at least one hardware processor, a context input; receiving, using at least one hardware processor a focal product represented by a product depiction; calculating, based on one or more of the focal product, the context input, the first grouping of products and the second grouping of products, using at least one hardware processor, an initial subset of product depictions to display on a first axis and a second axis wherein the focal product is associated with the first axis logic and the second axis logic; displaying, on a visual display of a user device, a user interface wherein a portion of the user interface comprises a subset of product depictions in the first grouping of products along the first axis, wherein the focal product is represented by a product depiction in the first axis, and wherein another portion of the user interface comprises a subset of product depictions in the second grouping of products along the second axis wherein the subset of product depictions in the second grouping are associated with the initial focal product; transmitting control signals to one or more sensors to perform measurements; receiving, using the at least one hardware processor and the one or more sensors, input data that comprises data characterizing a user gesture from the measurements; evaluating, using the at least one hardware processor, the input data characterizing the user gesture in relationship to the first axis logic and the second axis logic; selectively and automatically updating, at the visual display of the user device, the user interface, based on the input data characterizing the user gesture, wherein selectively and automatically updating includes one of updating in the user interface a product depiction representing the focal product to a next focal product depiction and updating one or more of the subset of product depictions in the first grouping along the first axis, the subset of product depictions in the second grouping along the second axis, both the subset of product depictions in the first grouping along the first axis and the subset of product depictions in the second grouping along the second axis, updating the subset of product depictions in the second grouping along the second axis.

In some embodiments, the method involves depicting the first axis vertically and depicting the second axis horizontally.

In some embodiments, the method involves receiving a third metadata value, third category, a third grouping, and a subset of products associated with the third grouping and displaying and updating a third axis.

In some embodiments, the first axis logic is associated with a first dimension representing a logical association between the focal product and the first category, and wherein the second axis logic is associated with a second dimension representing a logical association between the focal product and the second category.

In some embodiments, the logical association is one of a category match, contrasting category or complimentary category.

In some embodiments, the method involves calculating, based on the context input, first grouping of products and second grouping of products using at least one hardware processor an initial focal product represented by a product depiction; wherein the product depiction is one or more of a photograph, rendering, video clip, simulation, preview, thumbnails, audio file, interactive media, AI generated media, and/or a combination, and wherein the product depiction is represented by an identifier, link, or combination.

In some embodiments, the one or more sensors to perform measurements comprise a touch screen.

In some embodiments, the method involves modifying the second category logic based on the metadata associated with the first and/or next focal product.

In some embodiments, the user interface is one of a Graphical User Interface (GUI), Tangible User Interface (TUI) Natural User Interface (NUI), Augmented Reality (AR), Virtual Reality (VR), Mixed Reality, or combination.

In some embodiments, the method involves receiving using at least one hardware processor the focal product represented by the product depiction further comprises receiving instructions to determine a focal product based on at least one of a product promotion rating, the navigational context associated with a user, a random selection, a random selection within a search, a closest match selection within a search, a random selection within a category, a closest match selection within a category, a random selection within a product category or a closest match selection within a product category.

In some embodiments, the first category is associated with a product designed for covering a first portion of a wearer's body and the second category is associated with a product designed for a second portion of a wearer's body, wherein the first category is a first apparel category and wherein the second category is a second apparel category, and/or wherein the first and/or second category is associated with a color logic.

In some embodiments, the method involves using a model layout to display a multi-dimensional depiction of the product depiction representing the focal product and the subset of the product depictions as an outfit or arrangement.

In some embodiments, the method involves updating the visual display by visually highlighting the focal product over the non-focal products through one or more of the location in user interface, size, outline, visual indicators, color and/or color intensity, background color, visual flags or usage of a depiction format such as video or live photo.

In an aspect, embodiments described herein provide a processing system for selectively updating a visual display, the processing system having one or more processors and one or more memories coupled with the one or more processors, the processing system configured to cause a visual display to provide visual elements for a retail navigation environment at a user interface of the visual display, wherein a focal product and associated groups of product depictions at the visual display selectively and automatically update in response to one or more user gestures. The system involves: a communication interface to transmit a product depiction graphic user interface representation; one or more non-transitory memory storing a product model; wherein in the product model comprises a set of product data with elements associated with a product comprising: a product depiction associated with the product; two metadata values wherein the first metadata value comprises one of a value associated with a product taxonomy, a product characteristic, a combination of product taxonomy and product characteristic associated with the product and the second metadata value comprises one of a value associated with a product taxonomy, a product characteristic, a combination of product taxonomy and product characteristic associated with the product; an association between the first metadata value associated with a product with a first category and a second metadata value associated with the product with a second category; a logical association between the first category and the second category; a hardware processor programmed with executable instructions for generating visual elements of a product dimension navigation representation for a user interface of a visual display, wherein the hardware processor: transmits control signals to one or more sensors to perform measurements; receives from the one or more sensors input data that comprises data characterizing a user gesture; generates the product dimension navigation representation based at least in part on the input data characterizing the user gesture and product dimensions; a user device comprising a hardware processor, a visual display and an interface to receive the product dimension navigation representation; and activate, trigger, or present the product dimension navigation representation at the visual display or a user device output.

In some embodiments, the product dimension navigation representation comprises horizontal and vertical grids grouping products depictions based on axis logic and the product dimensions.

In some embodiments, the user device is one or more of a smart mirror, smart phone, computer, tablet, touchscreen kiosk, smart exercise device, fitness tracker, connected fitness system.

In some embodiments, the one or more sensors to perform measurements comprise a touch screen, a body motion detection sensor, a hand motion detection sensor, an arm motion detection sensor, a component within a connected smart exercise system, a computer, a tablet, a smart phone, a smart mirror, a smart mat, a smart watch, a smart sensor, a virtual reality headset, an augmented reality headset, a haptic glove, a haptic garment, a game controller, a hologram projection system, an autostereoscopic projection system, mixed reality devices, virtual reality devices, an augmented reality device, a metaverse headset, which may or may not be integrated in other devices.

In some embodiments, the system has one or more sensors to perform measurements to receive the input data.

In some embodiments, the one or more of the sensors is one or more of a resistive touchscreen, a capacitive touchscreen, a SAW (Surface Acoustic Wave) touchscreen, a infrared touchscreen, a optical imaging touchscreen, a Acoustic Pulse Recognition touchscreen.

In some embodiments, the system has a machine learning component with one or more machine learning models and/or an artificial intelligence component with one or more artificial intelligence models.

Embodiments described herein involve automated computer systems that may provide use for websites, software applications, retail environments, inventory management systems, and other digital tools, interfaces, and machine learning systems for categorizing products, prioritizing products to display, creating grouping logic, receiving a user gesture indicating a navigation within a set of products using measurements from sensors, evaluating the products within those groups and displaying a subset of the products within one or more of the groups.

For the purpose of this disclosure the term product is used to describe any physical, digital, and/or combination of physical and digital object that may be represented to a user through a depiction.

Embodiments described herein can receive a set of product data that defines two or more products (e.g. a plurality of products). Within a set of product data, a set of elements associated with the product provide a product depiction associated with the product. Embodiments described herein can involve different types or categories of retail products. An example product is apparel (e.g., accessory, garment, shoes). A product may constitute more than one product item, for example a matching set or outfit with multiple elements, pair of socks and/or shoes, package containing multiple items of an identical or similar type, series of workout activities, and so on.

Embodiments described herein can filter or pre-filter product data to identify or recommend two or more products, or a subset of product data associated with two or more products. Example input may indicate a scope, categorical, or category filter value which comprises one or more filter value that relate to aspects or attributes of products. In some implementations, a category filter is called a population filter. A category filter can include one or more categorical values, e.g., garment type as tights. In some embodiments, a category filter includes ordinal values like size, e.g., size XL. A category filter could include a product category filter, thematic filter, or the like. In some embodiments, at least one processor receives one or more filter values, and generates or identifies a set of product data based on the one or more filter values. Example filter values include, in a retail experience, gender (e.g., female, male, nonbinary, agender, androgyne, transgender, cisgender, bigender, two spirit), target age (e.g., group or range), brand, category (e.g., activity, apparel type), color, material, popularity, price, promotion, rating, size (e.g., ordinal value, range), season, theme (e.g., event, setting), or the like. Color and material are two examples of filters that can be implemented as filters by nominal variables in some examples. Color and material may be filters that have categorical (e.g., nominal) scales of measure and filters based on these are more like tags. Embodiments described herein can use one or more filter values to filter the product data. Embodiments described herein can use filter logic representing a logical association between filter values to filter the product data.

Embodiments described herein may provide a computer system to provide and/or generate output instructions for product navigation and depicting two or more products based on the users interaction with one or more components of the system and, the navigational history of the user and/or all other users. A user may interact with the system through a series of gestures captured as input data from measurements of sensors, for example. The user gestures may provide input to the system allowing the product navigation and products being depicted to be tailored to specific users. The system can monitor for user gestures and update an interface based on logic which will provide product depictions that respond to the user input data communicated through the gesture.

A user gesture can be characterized by input data from measurements of sensors, for example. A sensor can be any device that detects or measures a physical property (e.g., property of a material), records the detections or measurements, or transmits the detections or measurements. A sensor is a device that responds to a physical stimulus and generates a resulting measurement. A sensor can be a device, machine, or subsystem that detects events or changes in its environment, produces an output signal associated with sensing physical properties, and sends the information to other electronics, such as a hardware processor.

A user gesture can be characterized by sensor input captured by different types of devices such as a user device, mobile device, a smart phone, a tablet, a computer, a smart mirror, a wearable device (e.g., smart clothing, smart watch, smart jewelry, myographic band), an imager (e.g., camera, still camera, motion camera, color scanner, colorimeter, spectrocolorimeter, spectrophotometer, other imager), a keyboard, a pointer device, a touch screen, a haptic interface (e.g., haptic display, haptic glove, haptic footwear), a connected device (e.g., a yoga mat, a vehicle, cardiovascular exercise equipment, isometric or isotonic exercise equipment), a smart audiovisual system (e.g., smart speaker, lighting system), a wearable sensor (e.g., breathing monitor, blood glucose monitor, EEG, myographic band, heart rate monitor, blood oxygen monitor), an interface for processor generated experiences (e.g., headset, goggles, gloves, controllers for artificial, augmented reality (AR) or virtual reality (VR), and input devices (e.g. touchscreen, push button, camera, mouse, stylus, game controller). The user gesture can be a swipe, touch, augmented movement, facial gesture, hand gesture, touch, and so on. For example, touch related input is a method of communicating with an interface through an input device. Gesture sensors are devices that use sensors to capture and interpret user movements or input data as commands. In some embodiments, gestures may be received by microphone or other means which may improve accessibility. Different types of gestures can map to different commands.

Embodiments described herein can use different types of sensors, controllers, interfaces and input devices to captures input data characterizing user gestures. One or more processors process the input data to recognize and interpret user gestures.

Different types of sensors can be used to capture input, interpret input, and/or record the user gesture such as, for example, resistive film touch panel sensors, (analog) capacitive touch panel sensor, surface capacitive touch panel sensors, projected capacitive touch panel sensors, surface acoustic wave (SAW) sensors, infrared optical imaging touch panel sensors, Electromagnetic induction touch panel sensors, accelerometers, gyroscopes, Global Positioning System (GPS) sensors, camera sensors, video motion sensors, inertial sensors, IMU (inertial measurement unit) head tracker, Passive Infrared (PIR) sensors, active infrared sensors, Microwave (MW) sensors, area reflective sensors, lidar sensors, infrared spectrometry sensors, ultrasonic sensors, vibration sensors, echolocation sensors, proximity sensors, position sensors, inclinometer sensors, optical position sensors, laser displacement sensors, multimodal sensors, and the like are example sensors that may be used to make such measurements. A sensor device may be used to measure both physiological engagement and movement.

Embodiments described herein can involve performing measurements for obtaining the input characterizing a user current baseline behaviour. The input can be sensor data or electrical signals, for example.

In an aspect, embodiments described herein can provide a computer implemented method for providing output instructions for product navigation. The method can involve receiving, using at least one hardware processor a set of product data defining more than one product; wherein in the set of product data, a set of elements associated with the product provide, a product depiction associated with the product; two metadata values, wherein the first metadata value comprises one of a value associated with a product taxonomy, a product characteristic, a combination of the product taxonomy and the product characteristic associated with the product, and wherein the second metadata value comprises one of a value associated with a product taxonomy, a product characteristic, a combination of product taxonomy and product characteristic associated with the product; associating, using at least one hardware processor, the first metadata value associated with a product of a first category and a second metadata value associated with the product of a second category; categorizing, using at least one hardware processor, a first grouping of products, represented by product depictions, associated with the first category, and a second grouping of products, represented by product depictions, associated with the second category wherein the first grouping is associated with one or more sets of first axis logic associated with the first category and the second grouping is associated with one or more set of second axis logic associated with the second category; receiving, using at least one hardware processor a context input; receiving, using at least one hardware processor a focal product represented by a product depiction; calculating, based on one or more of the focal product, the context input, the first grouping of products and the second grouping of products using at least one hardware processor an initial subset of product depictions to display on a first axis and a second axis wherein the focal product is associated with the first axis logic and the second axis logic; displaying, on a user device, a user interface wherein a portion of the user interface comprises a subset of product depictions in the first grouping along a first axis, wherein the focal product is represented by a product depiction in the first axis; displaying, on a user device, a user interface wherein a portion of the user interface comprises a subset of product depictions in the second grouping along a second axis wherein the subset of product depictions in the second grouping are associated with the initial focal product; transmitting control signals to one or more sensors to perform measurements; receiving, using the at least one hardware processor and the one or more sensors, input data that comprises data characterizing a user gesture from the measurements; evaluating, using the at least one hardware processor, the input data characterizing the user gesture in relationship to a first axis logic and a second axis logic; automatically updating, at the user device, the user interface, based on the input data characterizing a user gesture, wherein automatically updating includes one of updating in the user interface a product depiction representing the focal product to a next focal product depiction and updating one or more of the subset of product depictions in the first grouping along the first axis, the subset of product depictions in the second grouping along the second axis, both the subset of product depictions in the first grouping along the first axis and the subset of product depictions in the second grouping along the second axis, updating the subset of product depictions in the second grouping along the second axis.

In some embodiments, in the set of product data, elements associated with a product comprises additional metadata.

In some embodiments, in the set of product data, elements associated with a product comprise additional product depictions.

In some embodiments, the first axis is depicted vertically and the second axis is depicted horizontally.

In some embodiments, the method involves receiving a third metadata value, third category, a third grouping, and a subset of products associated with the third grouping.

In some embodiments, the method involves displaying and updating a third axis.

In some embodiments, the first axis logic is associated with a first dimension representing a logical association between the focal product and the first category, and wherein the second axis logic is associated with a second dimension representing a logical association between the focal product and the second category.

In some embodiments, the logical association is one of a category match, contrasting category or complimentary category.

In some embodiments, the method involves calculating, based on the context input, first grouping of products and second grouping of products using at least one hardware processor an initial focal product represented by a product depiction; wherein the product depiction is one or more of a photograph, rendering, video clip, simulation, preview, thumbnails, audio file, interactive media, AI generated media, and/or a combination, and wherein the product depiction is represented by an ID, link, or combination.

In some embodiments, the method involves providing a product depiction comprises displaying more than one depiction associated with a product.

In some embodiments, the one or more sensors to perform measurements comprise a touch screen.

In some embodiments, image analytics to derive product characteristics from a product depiction.

In some embodiments, the method involves modifying the second category logic based on the metadata associated with the first and/or next focal product.

In some embodiments, the user interface is one of a Graphical User Interface (GUI), Tangible User Interface (TUI) Natural User Interface (NUI), Augmented Reality (AR), Virtual Reality (VR), Mixed Reality, or combination.

In some embodiments, the method involves receiving using at least one hardware processor a focal product represented by a product depiction; further comprises instructions to determine a focal product based on at least one of a product promotion rating, the navigational context associated with a user, a random selection, a random selection within a search, a closest match selection within a search, a random selection within a category, a closest match selection within a category, a random selection within a product category or a closest match selection within a product category.

In some embodiments, the navigational context further comprises a gesture and/or a selectable graphical user interface element for one or more of adding an item to a cart, adding an item to a wishlist, viewing additional product depictions, viewing additional product information, changing the category of items depicted, entering a search value, zooming in on a product depiction, zooming out on a product depiction.

In some embodiments, wherein instructions associate user metadata with the context data.

In some embodiments, the method involves providing instructions for an additional retail functionality comprising one or more of a shopping bag, a favourite, a product search or a product filter.

In some embodiments, the method involves filtering the set of product data using filter logic or a filter value.

In some embodiments, the product data defines apparel products.

In some embodiments, the first category is associated with a product designed for covering a first portion of a wearer's body and the second category is associated with a product designed for a second portion of a wearer's body.

In some embodiments, the first category is a first apparel category and wherein the second category is a second apparel category.

In some embodiments, the first and/or second category is associated with a color logic.

In some embodiments, more than one metadata value is used to associate a product with a first or second category.

In some embodiments, the user interface contains a model layout used to display a multi-dimensional depiction of the product depiction representing the focal product and the subset of the product depictions as an outfit or arrangement.

In some embodiments, the focal product is visually highlighted over the non-focal products through one or more of the location in user interface, size, outline, visual indicators, color and/or color intensity, background color, visual flags or usage of a depiction format such as video or live photo.

In some embodiments, the focal product depiction is displayed proximate to a middle portion of the first axis.

In some embodiments, instructions evaluate the number of product depictions to display based on user device capacities and device display size.

In some embodiments, the method involves mapping the user gesture to one or more commands for the product navigation in relationship to the first axis logic and the second axis logic.

Embodiments described herein provide a computer implemented method for generating output instructions for product navigation at a user interface of a user device.

The method involves: receiving, using at least one hardware processor a set of product data defining more than one product; wherein in the set of product data, a set of elements associated with a product provide, a product depiction associated with the product; two metadata values wherein the first metadata value comprises one of a value associated with a product taxonomy, a product characteristic, a combination of product taxonomy and product characteristic associated with the product and the second metadata value comprises one of a value associated with a product taxonomy, a product characteristic, a combination of product taxonomy and product characteristic associated with the product; receiving, using at least one hardware processor context metadata wherein the context metadata is one or more of device capacity, a language, a region, a date, a time, a device display size, a size of a window displayed on a device, a processor speed, a Wi-Fi or data connection capacity, a device type; receiving, using at least one hardware processor navigational context metadata wherein the context metadata is one or more of a search term, a search selection, a search category selection, a search product selection, a navigational history, a purchase history, a wishlist history, a promotion, a user history, a user purchase history, a user membership, a user gender, a user demographic characteristic, determining, using at least one hardware processor a focal product based on the product data and at least one of the context metadata, the navigational context metadata; analysing the metadata associated with the focal product, using at least one hardware processor to determine a first metadata value associated with the focal product with a first category and a second metadata value associated with the focal product and a second category; categorizing, using at least one hardware processor a first grouping of products, represented by product depictions, associated with the first category, and a second grouping of products, represented by product depictions, associated with a second category wherein the first grouping is associated with one or more set of primary axis logic associated with a first category and the second grouping is associated with one or more set of secondary axis logic associated with the second category; prioritizing a subset of products associated with product depictions associated with the first grouping and a subset of products associated with product depictions in the second grouping based on one or more set of logic; transmitting control signals to one or more sensors to perform measurements; receiving, using the at least one hardware processor and the one or more sensors to perform measurements, input data that comprises data characterizing a user gesture; evaluating, using the at least one hardware processor, the input data characterizing a user gesture in relationship to a first axis logic and a second axis logic; generating output instructions for one or more visual elements for product navigation at a user interface of a user device, the output instructions based on the input data characterizing a user gesture, wherein the output instructions define visual elements for a product depiction representing the focal product to a next focal product depiction and wherein the output instructions update one or more of the subset of product depictions in the first grouping along a first axis, the subset of product depictions in the second grouping along a second axis, both the subset of product depictions in the first grouping along the first axis and the subset of product depictions in the second grouping along the second axis, and update the subset of product depictions in the second grouping along the second axis; and transmitting the output instructions to the user device having the user interface to automatically update the one or more visual elements for the product navigation at the user interface.

In some embodiments, the method involves displaying, on the user device, the user interface wherein a portion of the user interface comprises the subset of product depictions in the first grouping along the first axis, wherein the focal product is represented by the product depiction in the first axis; displaying, on the user device, the user interface wherein a portion of the user interface comprises the subset of product depictions in the second grouping along a second axis wherein the subset of product depictions in the second grouping are associated with the initial focal product; and automatically updating, at the user device, the user interface, based on the output instructions.

In some embodiments, in the set of product data, elements associated with a product comprises additional metadata.

In some embodiments, in the set of product data, elements associated with a product comprise additional product depictions.

In some embodiments, the first axis is depicted vertically (or substantially vertically) and the second axis is depicted horizontally (or substantially horizontally).

In some embodiments, a third metadata value, third category, a third grouping, and a subset of products associated with the third grouping.

In some embodiments, the method involves displaying and updating a third axis.

In some embodiments, the method involves calculating, based on the context input, first grouping of products and second grouping of products using at least one hardware processor an initial focal product represented by a product depiction; wherein the product depiction is one or more of a photograph, rendering, video clip, simulation, preview, thumbnails, audio file, interactive media, AI generated media, and/or a combination, wherein the product depiction is represented by an ID, link, or combination.

In some embodiments, the method involves providing a product depiction comprises displaying more than one depiction associated with a product.

In some embodiments, the one or more sensors to perform measurements comprise a touch screen.

In some embodiments, image analytics derive product characteristics from a product depiction.

In some embodiments, the method involves associating user metadata with the navigational context.

In some embodiments, the method involves modifying the second category logic based on the metadata associated with the first and/or next focal product.

In some embodiments, the user metadata is one or more of user region, user purchase history, user navigational history, user wishlist, user size, user gender, user color preferences, user gift history, a search term, a search selection, a search category selection, a search product selection, a navigational history, a purchase history, a wishlist history, a promotion, a user history, a user purchase history, a user membership, a user gender or a user demographic characteristic.

In some embodiments, the user interface is one of a Graphical User Interface (GUI), Tangible User Interface (TUI) Natural User Interface (NUI), Augmented Reality (AR), Virtual Reality (VR), Mixed Reality, or combination.

In some embodiments, the subset of product depictions are selected based on one or more of the user data, the navigational context, or a combination of user data and navigational context.

In some embodiments, instructions associate user metadata with the context data.

In some embodiments, the method involves providing instructions for an additional retail functionality comprising one or more of a shopping bag, a favourite, a product search or a product filter.

In some embodiments, the method involves filtering the set of product data using filter logic or a filter value.

In some embodiments, the product data describes apparel products.

In some embodiments, the method involves the first category is associated with a product designed for covering a first portion of a wearer's body and the second category is associated with a product designed for a second portion of a wearer's body.

In some embodiments, the method involves the first category is a first apparel category and wherein the second category is a second apparel category.

In some embodiments, the first and/or second category is associated with a color logic. Color logic may include similar color, similar color pattern, complementary color, complementary color patterns, predefined color families, contrasting colors, contrasting color patterns, predefined color pattern families, color of detail or embellishment, color pattern of detail or embellishment, predefined color of detail or embellishment families, predefined color pattern of detail or embellishment family and/or combinations.

In some embodiments, more than one metadata value is used to associate a product with a first or second category.

In some embodiments, the user interface contains a model layout used to display a multi-dimensional depiction of the product depiction representing the focal product and the subset of the product depictions as an outfit or arrangement.

In some embodiments, the focal product is visually highlighted over the non-focal products through one or more of the location in user interface, size, outline, visual indicators, color and/or color intensity, background color, visual flags or usage of a depiction format such as video or live photo.

In some embodiments, the focal product depiction is displayed proximate a middle portion of the first axis.

In some embodiments instructions evaluate the number of product depictions to display based on user device capacities and user device display size.

In some embodiments, the method involves the method involves mapping the user gesture to one or more commands for the product navigation in relationship to the first axis logic and the second axis logic.

Embodiments described herein provide a processing system that includes one or more processors and one or more memories coupled with the one or more processors, the processing system configured to cause a user device to provide visual elements for a retail navigation environment at a user interface of a user device, wherein a focal product and associated groups of product depictions automatically update in response to one or more user gesture. The system has a communication interface to transmit the product depiction graphic user interface representation; one or more non-transitory memory storing a product model; wherein in the product model comprises a set of product data, elements associated with a product comprising: a product depiction associated with the product; two metadata values wherein the first metadata value comprises one of a value associated with a product taxonomy, a product characteristic, a combination of product taxonomy and product characteristic associated with the product and the second metadata value comprises one of a value associated with a product taxonomy, a product characteristic, a combination of product taxonomy and product characteristic associated with the product; an association between the first metadata value associated with a product with a first category and a second metadata value associated with the product with a second category; a logical association between the first category and the second category. The system has a hardware processor programmed with executable instructions for generating visual elements of a product dimension navigation representation for a user interface, wherein the hardware processor: transmits control signals to one or more sensors to perform measurements; receives from the one or more sensors to perform measurements input data that comprises data characterizing a user gesture; generates the product dimension navigation representation based at least in part on the input data characterizing the user gesture and product dimensions; a user device comprising a hardware processor, and an interface to receive the product dimension navigation representation; and activate, trigger, or present the product dimension navigation representation at a user device output; one or more sensor to received one or more specific user gesture.

In some embodiments, the product dimension navigation representation comprises horizontal and vertical grids grouping products depictions based on axis logic and the product dimensions.

In some embodiments, the user device is one or more of a smart mirror, smart phone, computer, tablet, touchscreen kiosk, smart exercise device, fitness tracker, connected fitness system.

In some embodiments, the one or more of the user device, the sensor, and the hardware processor are one or more components in a larger system providing a game, exercise and/or wellness content, virtual reality, augmented reality, mixed reality.

In some embodiments, the one or more sensors perform measurements comprise a touch screen, a body motion detection sensor, a hand motion detection sensor, an arm motion detection sensor, a component within a connected smart exercise system, a computer, a tablet, a smart phone, a smart mirror, a smart mat, a smart watch, a smart sensor, a virtual reality headset, an augmented reality headset, a haptic glove, a haptic garment, a game controller, a hologram projection system, an autostereoscopic projection system, mixed reality devices, virtual reality devices, an augmented reality device, a metaverse headset, which may or may not be integrated in other devices.

In some embodiments, the system has executable instructions for one or more of providing an input into a system or receiving an output from a system where the system is of one or more of a type exercise system, recommendation system, retail system, social networking community system, gaming platform system, membership system, inventory system, customer support system, activity tracking system, machine learning system.

In some embodiments, the one or more sensors to perform measurements to receive the input data.

In some embodiments, the one or more of the sensors is one or more of a resistive touchscreen, a capacitive touchscreen. a SAW (Surface Acoustic Wave) touchscreen, a infrared touchscreen, a optical imaging touchscreen, a Acoustic Pulse Recognition touchscreen.

In some embodiments, the system has a machine learning component with one or more machine learning models.

In some embodiments, the system has one or more of a virtual reality environment, an augmented reality environment, a mixed-reality environment, or a combination.

Embodiments described herein provide a non-transitory computer readable medium with instructions stored thereon, that when executed by a hardware processor causes the processor to: receive a set of product data defining more than one product, wherein in the set of product data, a set of elements associated with a product provide, a product depiction associated with the product, two metadata values wherein the first metadata value comprises one of a value associated with a product taxonomy, a product characteristic, a combination of product taxonomy and product characteristic associated with the product and the second metadata value comprises one of a value associated with a product taxonomy, a product characteristic, a combination of product taxonomy and product characteristic associated with the product; receive context metadata wherein the context metadata is one or more of device capacity, a language, a region, a date, a time, a device display size, a size of a window displayed on a device, a processor speed, a Wi-Fi or data connection capacity, a device type; receive navigational context metadata wherein the context metadata is one or more of a search term, a search selection, a search category selection, a search product selection, a navigational history, a purchase history, a wishlist history, a promotion, a user history, a user purchase history, a user membership, a user gender, a user demographic characteristic, determine a focal product based on the product data and at least one of the context metadata, the navigational context metadata; process the metadata associated with the focal product to determine a first metadata value associated with the focal product with a first category and a second metadata value associated with the focal product and a second category; categorize a first grouping of products, represented by product depictions, associated with the first category, and a second grouping of products, represented by product depictions, associated with a second category wherein the first grouping is associated with one or more set of primary axis logic associated with a first category and the second grouping is associated with one or more set of secondary axis logic associated with the second category; identify a subset of products associated with product depictions associated with the first grouping and a subset of products associated with product depictions in the second grouping based on one or more set of logic; and generate the output instructions to provide the product dimension navigation representation at a user interface of an electronic device.

Embodiments described herein can uses metadata values associated with products, such as values associated with a product taxonomy, a product characteristic, or a combination of product taxonomy and product characteristic associated with a product. There can be different categories of products. The categories can be associated with groupings of products. A grouping of products can be associated with one or more sets of axis logic associated with a category. A graphical user interface can display a subset of product depictions in a grouping along an axis logic associated with a category.

In some embodiments, a user gesture relates to the axis logic to control navigation of the subset of product depictions by triggering automatic updates to the graphical user interface. In some example embodiments, a product can be associated with one or more product dimensions. Product dimensions can include taxonomies with faceted and/or hierarchical structures. A product dimension can be associated with more than one taxonomy. A product dimension can be associated with dimension characteristics of a product. A product taxonomy can define a structured data set.

In some example embodiments, products or properties of products are associated with one or more identifiers (ID). A focal product may be a central or main product (e.g. product of focus) or characteristic of a product. For example, a focal product can be a category of apparel with common characteristics or attributes, such as upper body garment. Example embodiments involve receiving an ID associated with a focal product or receiving data properties associated with an ID for a focal product from a user device.

Within the system, the user device may be one or more of a smart phone, computer, tablet, smart exercise device, fitness tracker, smart mirror, connected fitness system, virtual reality device, virtual reality system, augmented reality device, augmented reality system, and the like. In some embodiments, the system further comprises a messaging system to provide a product depiction, product dimension depiction, product dimension navigation representation, or a means of accessing a product depiction, product dimension depiction, product dimension navigation representation to a user through one or more of email, SMS message, MMS message, social media notification or notification message on a user device.

This summary does not necessarily describe the entire scope of all aspects of various embodiments described herein. Other aspects, features and advantages can be provided by various embodiments.

### BRIEF DESCRIPTION OF THE DRAWINGS

Embodiments of the disclosure will now be described in conjunction with the accompanying drawings of which:

FIG. 1 shows an example system architecture for generating and/or providing two or more sets of product depictions according to embodiments described herein.

FIG. 2 shows an example system architecture for generating and/or providing two or more sets of product depictions according to embodiments described herein.

FIG. 3 shows an example method of providing product dimension navigation (PDN) according to embodiments described herein.

FIG. 4 shows an example method associated with receiving inputs, evaluating products, and displaying and selectively updating groups of product depictions, according to embodiments described herein.

FIG. 5 shows an shows an example method of generating associated with PDN according to embodiments described herein.

FIG. 6 shows an example user interface associated with and according to embodiments described herein.

FIG. 7 shows an example user interface associated with and according to embodiments described herein.

FIG. 8 shows an example user interface associated with and according to embodiments described herein.

FIG. 9 shows an example user interface associated with and according to embodiments described herein.

FIG. 10 shows an example user interface associated with and according to embodiments described herein.

FIG. 11 shows an example user interface associated with and according to embodiments described herein.

FIG. 12A shows an example user interface associated with and according to embodiments described herein.

FIG. 12B shows an example user interface associated with and according to embodiments described herein.

FIG. 12C shows an example user interface associated with and according to embodiments described herein.

FIG. 12D shows an example user interface associated with and according to embodiments described herein.

FIG. 14 shows an example method associated with PDN axis logic according to embodiments described herein.

FIG. 15 shows an example method associated with PDN and/or focal product according to embodiments described herein.

FIG. 16 shows an example method associated with PDN and/or AI/ML augmented models according to embodiments described herein.

### DETAILED DESCRIPTION

The methods and systems involve a hardware processor having executable instructions to provide one or more product dimension representations based on an engagement evaluation determined based on one or more inputs characterizing user engagement and an activity associated with the engagement of the user and or groups of users.

Embodiments described herein relate to selective visual display systems that provide or display visual elements for a retail navigation environment. Embodiments described herein relate to systems and methods for selectively updating visual displays for product navigation. Embodiments described herein relate to systems and methods for selectively updating visual displays by changing product depictions based on gestures. For example, the product depictions can be visual product depictions associated with a product. Embodiments described herein can involve selectively and automatically updating, at a visual display, a user interface based on the input data characterizing a user gesture. For example, selectively and automatically updating visual displays can include one of updating in the user interface a product depiction representing the focal product to a next focal product depiction and updating one or more of a subset of product depictions in a first grouping along a first axis, a subset of product depictions in a second grouping along a second axis, both the subset of product depictions in the first grouping along the first axis and the subset of product depictions in the second grouping along the second axis, updating the subset of product depictions in the second grouping along the second axis, and so on. Visual display systems can include a range of different devices that provide, present or display visual data, such as images, video, and text. Electronic visual displays may also be referred to as screens, for example. Visual display systems may have size constraints in relation to displaying visual element. Some embodiments described herein relate to systems and methods for selectively updating visual displays for product navigation by selecting, identifying, choosing or generating visual product depictions, such that visual display selectively and automatically updates a focal product and associated groups of product depictions in response to one or more user gestures.

There is a need for improved systems, methods, and non-transitory computer readable medium with instructions stored thereon to generate, provide, navigate, update, and interact with product dimensions, product dimension navigation interfaces, two or more product dimension, a set of product dimensions associated with a set of axis, which the systems, methods, and non-transitory computer readable medium with instructions stored thereon disclosed addresses.

A product can be associated with one or more product dimensions. Product dimensions can include taxonomies with faceted and/or hierarchical structures. A product dimension can be associated with more than one taxonomy. In the case of a hierarchal taxonomy, the product data and/or product model may form a structured taxonomy for example species, genus, family, order, class, division, domain. Product dimensions can include characteristics which may or may not be associated with a hierarchical logic. In a taxonomy, a product dimension logic may be associated with a specific characteristic or grouping of characteristics which are shared amongst a group/category of products. A product characteristic, may be associated with one or more taxonomy wherein the taxonomy may be faceted, hierarchical, or a combination of faceted and hierarchical. Certain characteristics associated with a product may be associated with both one or more hierarchical taxonomy and/or one or more faceted taxonomy. For example, a characteristic such as a product price or color may be affiliated with both a non-hierarchical product characteristic which may be evaluated in relationship to other non-hierarchical product characteristics (associated with products with a similar color, price) and to a hierarchical product taxonomies such as price ranges or color groupings.

Product dimensions can include characteristics which may or may not be associated with similar characteristics or similar values and/or value types associated with a characteristic. Various affiliations may be made among the characteristic values for example in some logic systems a shirt and a jacket are determined to be closer affiliates than a shirt and a sock. In some logic systems a white shirt and a white sock may be determined as closer affiliates.

Product dimensions can be used to identify product groupings through affiliations based on one or more dimension matches. For example, products sharing the same dimension for a product attribute or characteristic (e.g. color and/or garment type) can be included into a product grouping in which the dimension or characteristic for a product attribute (e.g. shading) varies amongst the product group. In some embodiments, a product can be associated with a category, and a product may be associated with multiple characteristics. In some embodiments, a dimension for the product can define a grouping of products that have a common category or shared characteristics, but also have different or varying characteristics or attributes. In some embodiments, the combination of dimensions may be associated with a value based on the combination of the dimensions for example a color mood which combines values associated with two color dimensions or a total purchase/outfit budget which combines values associated with two price dimensions.

Product data set includes metadata for two or more products (e.g. a plurality of products), in which the data for each product included in the data set includes two or more product depictions and two or more metadata values associated with each product. The two or more metadata values associated with each product are composed of product values associated with either a single characteristic, one or more taxonomy values, or a combination of taxonomy and characteristic values.

A model can be a computer model that encodes machine executable instructions to configure a hardware processor to implement operations to process input data and generate output data. The model can be trained using training data, and updated using feedback data. The model can be the output of the training process and can be instructions to configure hardware processors to detect patterns and generate values as output data. There can be different types of computer models. Models can be based on navigational data from a specific users past interactions with the system and/or from groups of past users who share one or more identifiers with the user. Navigational data from a group of past users will be used in the model when an identifier such as region, demographic, access time frame, purchase engagement criteria, membership level, or a combination of these identifiers match the identity of the user interacting with the system.

User input can be gestures, or other navigational input, sensor data or electrical signals, for example. The input data can be captured in real-time or near real-time. In some embodiments, the method and system can involve performing measurements for obtaining the inputs characterizing user navigation related to a product depiction. In some embodiments, the method and system provide a series of engagement evaluations which are associated with one or more activity of the user, one or more product depiction, over a time duration.

In some embodiments, the user engagement evaluation is associated with and/or compared to user navigation, user purchase and user interaction with the platform.

The user interface selectively updates based on user interaction with product depictions within product dimensions, product dimensions, product dimension logic, product dimension controls.

Embodiments described herein transmit signals to one or more controllers and/or sensors to preform measurements and receive an input characterizing a user product exploration, navigation or purchase, associated with a user interaction with a user interface. Embodiments described herein can involve using one or more sensors to perform measurements and receiving, from the measurements, input characterizing a user movement or location.

In some embodiments, the product and/or product depiction engagement is evaluated, assessed, or estimated based on data and data models associated with the user, another user, a model of a user with specific characteristics, an activity, a model of an activity with specific characteristics, a skill level, a demographic, metadata associated with an activity, and the like. Embodiments provide improved evaluation and processing of navigational and/or sensor data to increase the accuracy of feedback and/or to increase the efficacy of models and/or accuracy of detected relationships within the data. Embodiments described herein can generate, use, and/or train models for product dimension prioritization, product dimension subset prioritization, product prioritization, product depiction prioritization, dimension associations, product associations, dimension models, retail models, user models, engagement evaluations and the like. Models can be computer programs or code representations of machine learning or artificial intelligence processes that may be trained with datasets to improve product exploration and product purchase conversions.

Embodiments relate to methods and systems with non-transitory memory storing instructions and data records for product dimensions, product relationships, depicting product dimensions, product dimension characterization, product characterization, product depiction characterization, user engagement characterization, user characterization, and/or activity characterization. Embodiments relate to generating and providing a user within a navigational interface such as a GUI, virtual-reality environment, augmented reality environment, or the like, product depictions, related products, dimensions associated with one or more product, prioritization of related products, group of product dimensions, one or more axis of product dimensions, additional product information, and/or other information based on a calculated user engagement. This navigational interface and/or other information may include real-time or near real-time feedback related to specific user engagement, a preferred engagement-activity interrelation, assigning points to an engagement activity interrelation or a combination of the above.

In some embodiments, a product depiction may include generating and/or providing executable instructions to present, remove, unlock, or customize one or more of a physical product, digital product, personalization, a feature, a retail offer, a retail experience, a user profile, a user wish list of products or services, a class, a group activity, a workshop, a coaching session, a video, a song, a graphic user interface skin, a performance event, community event, an exercise class, an avatar, an avatar's clothing, an avatar accessory, a conversational interaction, a notification, a pop-up suggestion, an alarm, a badge or a group membership. In some embodiments, the navigational interface or a value calculated based on the navigational interface, is an input to an exercise platform, retail platform, social media community platform, augmented reality platform, virtual reality platform, mixed-reality platform or combination thereof.

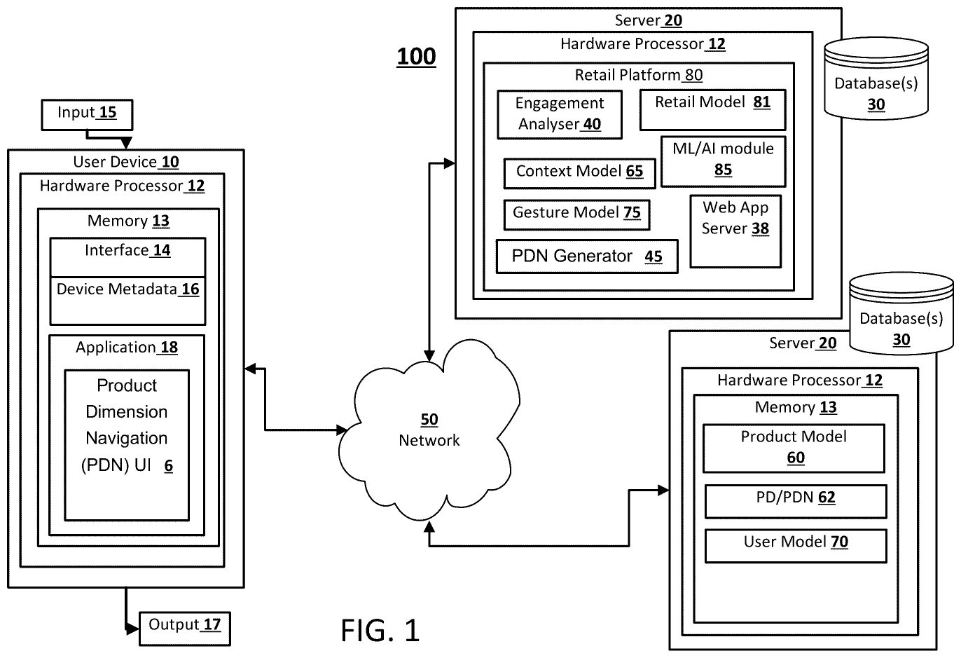

Turning to FIG. 1, there is shown an embodiment of product dimension navigation (PDN) system 100 that may generate and/or provide two or more sets of product dimensions and selectively update product dimensions depicted in response to an evaluation of inputs associated with user engagement. In some embodiments, PDN system 100 selectively updates a visual display and provides output instructions for product navigation in response to one or more user gestures. In some embodiments, PDN system 100 can be referred to as a selective visual display system. PDN system 100 can select, determine or identify one or more product dimension representations based on an engagement evaluation which may be determined e.g., based on one or more inputs characterizing user engagement and an activity associated with the engagement of the user and or groups of users. PDN system 100 can select, determine or identify product depictions based on gestures and selectively update visual displays by changing product depictions based on gestures.

PDN system 100 may implement operations of the methods described herein. PDN system 100 has hardware servers 20, databases 30 stored on non-transitory memory, a network 50, and user devices 10. Servers 20 have hardware processors 12 that are communicatively coupled to databases 30 stored on the non-transitory memory and are operable to access data stored on databases 30. Servers 20 are further communicatively coupled to user devices 10 via network 50 (such as the Internet). Thus, data may be transferred between servers 20 and user devices 10 by transmitting the data using network 50. The user devices 10 include non-transitory computer readable storage medium storing instructions to configure one or more hardware processors 12 to provide an interface 14 for collecting data and exchanging data and commands with other components of the system 100. The user devices 10 have one or more network interfaces to communicate with network 50 and exchange data with other components of the system 100. The servers 20 may also have a network interface to communicate with network 50 and exchange data with other components of the system 100.

A number of users of PDN system 100 may use user devices 10 to exchange data and commands with servers 20 in manners described in further detail below. For simplicity of illustration, only one user device 10 is shown in FIG. 1, however, PDN based on an input characterizing a user engagement and a user activity and/or location system 100 can include multiple user devices 10, or even a single user device 10. In some embodiments, system 100 may be associated with and/or comprise retail platform 80, which may include one or more multiple regional or a global retail platforms within retail platform 80. Retail platform 80 may be associated with multiple regions and may be accessed by thousands, or millions of users at the same time and such users may be associated with a regional platform or one or global platform.

In some embodiments, server 20 includes a messaging system to exchange data and commands user devices 10. Such a messaging system may be a component of retail platform 80. The messaging system can also be integrated as part of interface 14 to provide a product depiction, product dimension depiction, product dimension navigation representation, or a means of accessing a product depiction, product dimension depiction, product dimension navigation representation to a user through one or more of email, SMS message, MMS message, social media notification, or notification message, on a user device.

The user devices 10 may be the same or different types of devices. The PDN system 100 is not limited to a particular configuration and different combinations of components can be used for different embodiments. Furthermore, while PDN system 100 shows two servers 20 and two databases 30 as an illustrative example related to generating and/or providing a PDN output. PDN system 100 extends to different numbers of (and configurations of) servers 20 and databases 30 (such as a single server communicatively coupled to a single database). The servers 20 can be the same or different types of devices.

The user device 10 has at least one hardware processor 12, a data storage device 13 (including volatile memory or non-volatile memory or other data storage elements or a combination thereof), and at least one communication or network interface 14. The user device 10 components may be connected in various ways including directly coupled or indirectly coupled via a network 50. The user device 10 is configured to carry out the operations of methods described herein.

According to some embodiments, user device 10 is a mobile device such as a smartphone, although in other embodiments user device 10 may be any other suitable device that may be operated and interfaced with by a user. For example, user device 10 may comprise a laptop, a personal computer, an interactive kiosk device, immersive hardware device, smart watch, smart mirror or a tablet device. User device 10, may include multiple types of user devices and may include a combination of devices such as smart phones, smart watches, computers or tablet devices, within system 100.

The user device 10 may be a smart exercise device, or a component within a connected smart exercise system. Types of smart exercise devices include smart mirror devices, smart treadmill devices, smart stationary bicycle devices, smart home gym devices, smart weight devices, smart weightlifting devices, smart bicycle devices, smart exercise mat devices, smart rower devices, smart elliptical devices, smart vertical climbers, smart swim machines, smart boxing gyms, smart boxing bags, smart boxing dummy, smart grappling dummy, smart dance studio, smart dance floor, smart dance barre, smart balance board, smart slide board, smart spin board, smart ski trainer, smart trampoline, smart vibration platform, and so on.

User in such systems may also input data and/or receive product depictions through different devices such as a camera, video camera, a microphone type sensor, a hologram projection system, an autostereoscopic projection system, virtual reality headset, an augmented reality headset, mixed reality devices, virtual reality devices, an augmented reality device, a metaverse headset, a haptic glove, a game controller or a haptic garment, which may or may not be integrated in other devices. User device 10 comprise or connect to such input 15 and/or output 17 devices and/or component hardware in user device 10. User device 10 can receive output product depictions as output 17.

Each hardware processor 12 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. Memory 13 may include a suitable combination of any type of computer memory that is located either internally or externally.

Each network interface 14 enables computing device 10 to communicate with other components, to exchange data with other components, to access and connect to network resources, to serve applications, and perform other computing applications by connecting to a network 50 (or multiple networks) capable of carrying data. The communication or network interface 14 can enable user device 10 to interconnect with one or more input 15 devices, such as a keyboard, mouse, camera, touch screen, sensors and a microphone, or with one or more output devices such as a display screen and a speaker.

The memory 13 can store device metadata 16 which can include available metadata for factors such as memory, processor speed, touch screen, resolution, camera, video camera, processor, device location, haptic input/output devices, augmented reality glasses or virtual reality headsets.

User device 10 receives (or couples to) one or more input 15 characterizing a user engagement. The input 15 can be sensor data or electrical signals, for example. In some embodiments, the input 15 can include sensors (or other devices) for performing measurements for obtaining sensor data or electrical signals characterizing a user navigation of product depictions.

In some embodiments, application 18 on user device 10 comprises a PDN UI 6. User device 10 can be configured for selectively updating a visual display and providing output instructions for product navigation in response to one or more user gestures. In some embodiments, product depictions in PDN UI are generated by PDN generator 45 on server 20. In some embodiments, product dimensions (PD) and product dimension navigation components are stored in Server 20 memory, for example PD/PDN model and/or repository 62. In some embodiments PD/PDN is stored in one or more database 30, retail platform 80, product model 60, similar, or a combination thereof. In some embodiments, PDN UI 6 comprises product depictions associated with two or more dimensions. PDN UI 6 may be a component of application 18, retail platform 80 or another appropriate component of system 100 or system 200.

PDN UI 6 displays (e.g. at a visual display system) prioritized product depictions, determined based on a computed model in conjunction with product model 60, PDN generator 45, PD/PDN model/repository, ML module 85, combinations thereof and the like within system 100 and/or system 200. PDN UI 6 provides a representation of the calculated results of focal product, dimension logic, category logic, grouping logic, prioritization logic, the association of dimensions with one or more axis, and the like to provide a visual and/or spatial depiction of two or more product dimensions simultaneously. The visual and/or spatial depiction can involve visual elements. Such a representation of two or more different product dimensions simultaneously enables the user to navigate through other dimensional relationships between products and engage with product depictions in an engaging manner that enables improved product discovery.

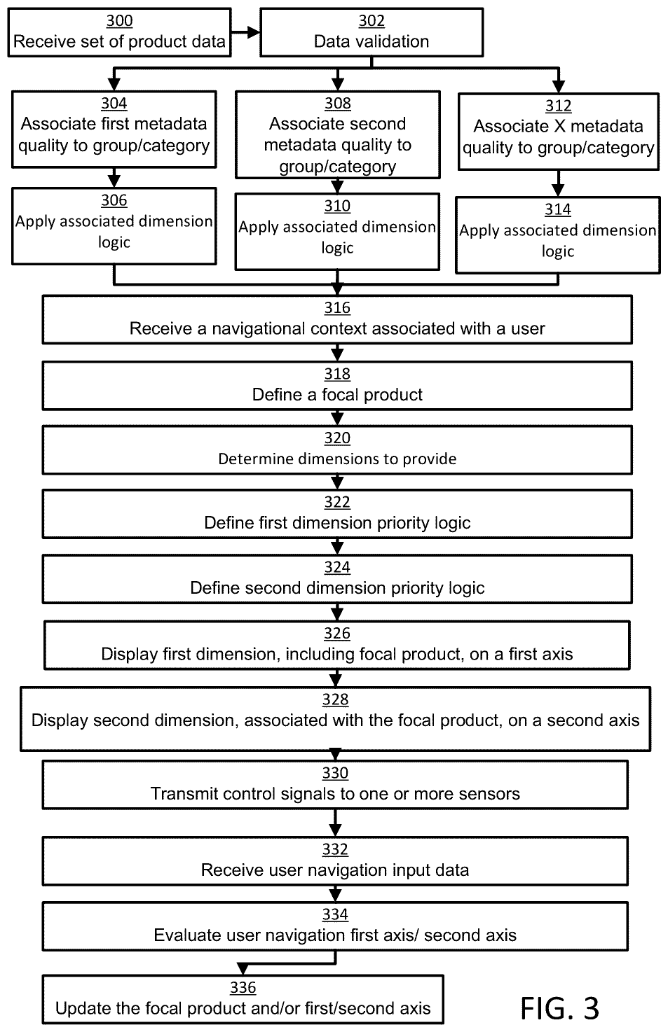

See, for example, FIGS. 3, 5, 14, 15 and 16 for methods associated with calculating, generating, and providing depictions associated with focal products, dimensions associated with focal products, groupings of dimensions, prioritization logic for products to depict associated with one or more dimension associated with the focal product, updating the focal product, and using AI/ML to update and improve models.

PDN UI 6 may be represented using a Graphical User Interface (GUI), Tangible User Interface (TUI) Natural User Interface (NUI), Augmented Reality (AR), Virtual Reality (VR), other UI representation modes or a combination. In some embodiments, PDN UI 6 has one or more visual elements for product navigation or a retail navigation environment, and application 18 (e.g. instructions or code) cause the user device 10 to provide the visual elements of the PDN UI 6 for the product navigation or a retail navigation environment. For example, the PDN UI 6 can be a GUI of the visual elements, or the PDN UI 6 can be an AR or VR environment with visual elements (e.g. two dimensional or three dimensional elements) of product dimensions. In some embodiments, within a GUI, TUI, NUI, or for example virtual reality, augmented reality, projection screen and the like, additional dimensions, for example a third dimension or more dimension may be provided and depicted within the PDN UI 6. In some embodiments, PDN UI transitions depictions between various sets of dimensions and dimensions which are depicted automatically, based on user input, context metadata and navigation context metadata, or through a combination.

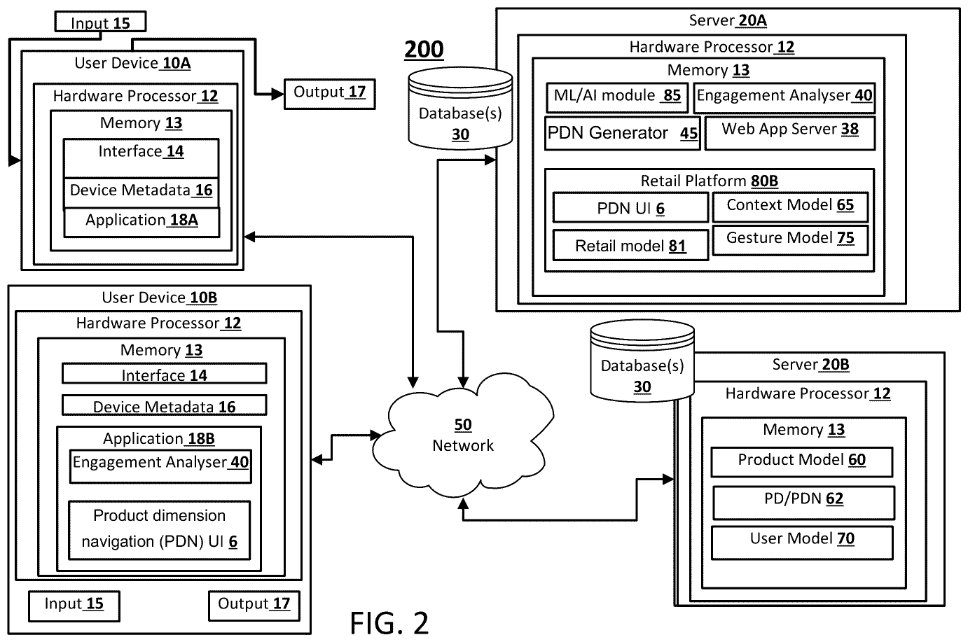

In FIG. 1 the example server architecture includes a server 20 and PDN Generator 45 providing a Product Dimension Navigation (PDN) UI 6 in application 18 to user device 10. In other example architectures, similar functionality is performed by server 20, web app server 38, or retail platform 80 (FIG. 2). Executable instructions or code components such as engagement analyser 40, PDN generator 45, product model 60, retail platform 80, Context model 65, Gesture Model 75, Engagement Analyser 40, ML Module 85, and Product Model/repository 60 may be installed on more than one server 20 within system 100. Server 20 can generate, use, and/or train product model 60, user model 70, Gesture model 75, Context model 65, for engagement evaluations and generating PDN responses and PDN representations. Models can be computer programs or code representations of machine learning or artificial intelligence processes that may be trained with datasets to obtain output results for the PDNs and PDN representations. In some example architectures, engagement analyser 40, PDN generator 45 may be installed on user device 10. In some embodiments, one or more of engagement analyser 40, PDN generator 45, engagement model 60, Product model/repository 60, PD/PDN repository 62, activity Model 65, companion model 75 are combined. In some embodiments there is a product model 60 which contains underlying values which may be used to generate a dimension, PD, or PDN and/or be associated with the PD/PDN model 62. In some embodiments, retail platform 80 may be a product management system that provides product information but does not comprise a product purchase component.

The server 20 has at least one hardware processor 12, a data storage device 13 (including volatile memory or non-volatile memory or other data storage elements or a combination thereof), and at least one communication or network interface. The server 20 components may be connected in various ways including directly coupled or indirectly coupled via a network 50. The server 20 is configured to carry out the operations of methods described herein.

User device 10 includes input and output capacity (via network interface 14 or I/O interface), a hardware processor 12, and computer-readable medium or memory 13 such as non-transitory computer memory storing computer program code. Input device 15 may be integrated within user device 10 or connected in various ways including directly coupled or indirectly coupled via a network 50. The input device 15 can perform verifications and scans. For example, the input device 15 can include (or couple to) one or more sensors that can measure movement, gestures, breathing patterns, location, heartrate, codes, and IDs relating to a user, activity, or its environment or context. The input device 15 can perform measurements for obtaining input data. A hardware processor 12 can receive input data from the sensors and inputs 15. Similarly, output device 17 may be integrated within user device 10 or connected in various ways including directly coupled or indirectly coupled via a network 50. The output device 17 can activate, trigger, or present one or more PDN over a time duration.

For example, output device 17 can activate or trigger audio associated with a PDN at a speaker device. As another example, output device 17 can present a visual image or series of images associated with a product depiction, PD and/or a PDN at a visual display device. As a further example, output device 17 can provide a virtual reality headset experience to enable a virtual experience type PDN. In some embodiments, output device 17 incorporates or integrates a visual display.

The PDN system 100 may involve different types of devices to generate different types of discernible effects to provide a PDN experience. In some embodiments, multiple PD, sets of PD, focal products associated with a PD and/or PDN can be provided over a time period. In some embodiments, different dimensions within a PD are prioritized and/or displayed at different times. In some embodiments, PDN system 100 provides a selective visual display system that displays or prioritizes different dimensions within a PD at different times. For example, a first set of PD can be provided at a first time, a second PD can be provided at a second time, and so on. In some embodiments, more than one PDN can be provided simultaneously at a first time, and another PDN can be provided a second time, and so on. In some embodiments, selected PDN may be stored and provided at a later time. An example of this is a graphical user interface showing the user a series or collection of PD and/or PDN associated with a product they are viewing, have recently viewed, have purchased, have added to a wishlist, have viewed other products with a similar attribute, have viewed other products often bought with other items in a PD, have completed, or have completed in the past. In some embodiments, the PD is provided in response to a search, product selection, product purchase, user metadata, or the like. User device 10 may be coupled with more than one input device 15, more than one output device 17, and more than one of both input device 15 and output device 17. A single device may contain input device 15 and output device 17 functionality, a simple example of this would be a connected headset with integrated microphone.

In FIG. 1, there is shown an embodiment of a user device 10 where the application 18 includes executable instructions for displaying information related to providing PDN UI 6. For example, in an embodiment, application 18 may be an application providing a retail environment and/or streaming exercise content displayed on a smart mirror user device 10 which includes executable instructions related to the generating and/or providing of CER. Application 18 may be one or more application provided by user device 10. For example, one application 18 program may provide functionality related to capturing sensor data related to a user activity and one application 18 may provide functionality related to providing a PDN. Application 18 may provide a web browser type program, or other application that enables a user to access PD/PDN 62 stored on server 20B as shown in FIG. 2.

In some embodiments, the function of databases 30 may be implemented by servers 20 with non-transitory storage devices or memory. In other words, servers 20 may store the user data located on databases 30 within internal memory and may additionally perform any of the processing of data described herein. However, in the embodiment of FIG. 1, servers 20 are configured to remotely access the contents of databases 30, or store data on databases 30, when required.

In some embodiments, there are provided systems, methods, and executable instructions for synchronizing sensor input including the one or more input characterizing a user gesture and one or more input characterizing a user movement. This synchronization may include a means of user calibration, date-time stamp verification and alignment, establishing master-slave sensor relationships, using a timing transport protocol such as IRIG (Inter-Range Instrumentation Group), GPS PPs (Global Positioning System Pulse Per Second), NTP (Network Time Protocol), EtherCAT (Ethernet for Control Automation Technology) PTP V2 (Precision Time Protocol) and the like to ensure sensor synchronization.

Turning to FIG. 2, there is shown another embodiment of a user device 10A where the application 18A includes executable instructions for accessing product dimension navigation representations on server 20A. As shown in FIG. 2, PDN UI 6 can be provided in memory 13 on server 20A and/or PDN UI 6 may be provided in retail platform 80B, or another component, providing information concerning products, product dimensions, product dimensions, product engagement, retail, inventory and/or user engagement responses. As shown in FIG. 2, with example user device 10B, application 18B can also provide functionality associated with engagement analyser 40, PDN UI 6, to provide PDN 6 within memory 13 of a user device 10B.

In some embodiments, models include product model 60, PD/PDN model 62, context model 65, gesture model 75, user model 70, retail platform model 80. These models may be stored in memory 13 or database 30. In some embodiments, context model 65 is integrated in PD/PDN repository 62 and/or retail platform 80 is integrated in machine learning module 85. Models are encoded instructions or programs that are executable by hardware processors to recognize patterns in data or make predictions.

The PDN system 200 evaluates product data and patterns, user input including sensor data (captured through sensors/input 15 and received as input data) to generate a two or more product dimensions and a product depiction navigation which is a factor in generating a provided and/or candidate PD and/or PDN. One or more PD are determined and based on the product data and other inputs (such as user engagement, activity associated with the engagement of the user and or groups of users, engagement analyser 40, contextual model 65, companion model 75, activity platform 85, device metadata 16), one or more PDN (representation of the PD or a subset of the PD) are generated and provided. In some embodiments, the device metadata data 16 and/or application 18 functionality shown on user device 10 is integrated in ML module 85 and/or retail platform 80.

In some embodiments, a PDN is generated as executable instructions stored within application 18. In some embodiments the PD and/or PDN is streamed to user device 10 through network 50. The user device 10 and/or output device 17 may be a device such as a smart phone, smart exercise mirror, or a virtual reality connected device.

The PD/PDN system 200 has non-transitory memory storing data records, product data, context data, user purchase data, activity data, user location and/or movement data, user data, activity data, and additional metadata received from a plurality of channels, at servers 20 and databases 30. For example, the data records can involve a wide range of data related to users, user purchase history, user navigational history, user navigation patterns, user preferences, user types, user activity, user schedules, user regions, user purchases, user context, activity types, user device capacity, feel-states, product descriptions, product purchase history, product combination purchase history, product navigation history, product engagement, product combination engagement, product combination navigation history, product types, product categories, product characteristics, product taxonomies, product hierarchies, product colors, product sizing, product availability, retail regions, retail offers, retail promotions, device metadata, product depiction characteristics, product depiction conversion history, product depiction color characteristics, product depiction type, additional product data, and the like. The data involves structured data, unstructured data, metadata, text, numeric values, images, biometric data, physiological data, activity data, renderings based on images, video, audio, sensor data, and so on.

For example, the contextual data includes data that pertains to the context for the user and/or navigational history associated with PDN. Contextual data includes the user's physiological, movement, and/or location, sensor inputs, generating an engagement evaluation, purchase history of the user, purchase history of all users, purchase history of users based on one or more demographic factor and purchase history of all users based on a non-demographic factor.

In some embodiments, contextual model 65 data contains data identifying qualities such as retail purchases, navigation conversion, activity history, wishlist, content, wishlist history, cart content, cart history appropriate to PDN generation/providing and/or evaluating engagement with PDN. PDN context may be evaluated based on the activity type/location, specific contextual user data, user classification metadata, user current navigational activity, user other activity, user historical activity, specific contextual retail activity, categories of retail activity, specific contextual activity/movement profile data, categories of activity/movement profile data, specific contextual, specific feel state data, categories of feel state data, data, and so on. In some embodiments, input device 15 provides one or more elements of the context data.

In some embodiments, the system further comprises a messaging system to provide a product depiction, product dimension depiction, product dimension navigation representation, or a means of accessing a product depiction, product dimension depiction, product dimension navigation representation to a user through one or more of email, SMS message, MMS message, social media notification, notification message on a user device. Such a messaging system may be a component of retail platform 80.

There will now be described methods for generating PD and/or PDN for a user device 10 based on receiving product data for more than one product where the product data comprises one or more product depiction and two or more metadata characteristics associated with the product. Additional user gesture based or other input, such as a search term, selection of a product, category, or descriptor are potential inputs to the PDN system causing the update and regeneration of PDN and subsets of PDN to provide.

Sensor and/or other input device input) characterizing a user physiological data, location and/or movement, and activity models, and providing a representation of the PD to the user. The methods can involve transmitting control signals to one or more sensors and/or controllers to perform measurements (e.g., using sensors and cameras) relating to a user and user activity, user navigational intention, and/or an environment. The methods can involve triggering, activating, or presenting one or more PD, products associated with a PD, products associated with a subset of a PD, product depictions associated with a PD, product depictions associated with a subset of PD, and/or PDN to provide discernible effects, including providing a user interface and/or portion of a user interface, actuation of physical hardware components. The methods can involve providing a PDN associated with a representation associated with the video or image of a product displayed. The methods can involve receiving from a user one or more input(s) and generating and/or providing one or more PD and/or PDN. Accordingly, the methods involve computer hardware and physical equipment to perform measurements for the input data, and/or provide discernible product dimension navigation representations based on product metadata, a focal product and/or user engagement evaluation.

Methods, and aspects or operations of methods are shown generally in FIGS. 3-5 and 14-16 which show diagrams of the steps that may be taken to provide and generate a PD, prioritization of PD display, prioritization of product depictions within a PDN, PDN, and/or engagement evaluation based on one or more input characterizing a product characteristic, characterizing a product dimension, an input characterizing a user's engagement, and/or an input characterizing a user navigation. The steps shown in FIGS. 3-9 are exemplary in nature, and, in various embodiments, the order of the steps may be changed, and steps may be omitted and/or added without departing from the scope of the disclosure. Methods can perform different combinations of operations described herein to provide or generate product dimensions (PD) and product dimension navigation (PDN) representations associated with products and retail platform product navigation.

Turning to FIG. 3, in accordance with some embodiments, there is a method of providing a PDN characterizing dimensions associated with one or more product. The method can involve providing output instructions for PDN. For example, providing can involve making the output instructions available to hardware components or devices, such as by transmission to hardware components or a device with an interface, visual display at the device with the interface, and/or storing on a memory accessible by different hardware components (e.g. of system) or devices so that the output instructions are accessible by the different hardware components or devices.

Methods associated with embodiments, involve transmitting control signals to one or more sensors to perform measurements, and receiving, using a hardware processor and one or more sensors to perform measurements, input data that includes data characterizing a user's navigation input and/or navigation over time and data characterizing a user's activity and/or activity over time.

The process may be initiated from a number of different contexts such as an online digital retail environment, participating within a smart mirror based activity (exercise class, training session, concert), a workout or wellness activity performed by an individual, a virtual reality context, a wellness recommendation system, an online social media environment, a retail environment, and/or using an application specifically for evaluating products and providing information about more than one product dimension.

The process may be triggered, as part of a retail environment, machine learning system, or the like initially independent of a specific user engagement. In some embodiments, the hardware processor is associated with server 20, with hardware processor 12, memory 13 storing with PDN generator 45.

Receive set of product data 300 comprises receiving, using at least one hardware processor, a set of product data defining two or more products (e.g. a plurality of products) wherein in the set of product data, elements associated with a product provide, one or more product depiction(s) associated with the product; two or more metadata values wherein the first metadata value comprises one of a value associated with a product taxonomy, a product characteristic, a combination of product taxonomy and product characteristic associated with the product and the second metadata value comprises one of a value associated with a product taxonomy, a product characteristic, a combination of product taxonomy and product characteristic associated with the product.

In some embodiment the product data 300 comprises a large number of metadata values associated with a product, characteristics associated with a product, and/or taxonomies associated with a product. Product data taxonomies may be hierarchical, faceted, and/or a combination hierarchical and faceted taxonomies. In some embodiments, product model 60 and/or product data are integrated within retail model 81 and associated data or vice versa.

Data validation 302 may include various forms of data validation for data correctness and/or other factors such as regional availability, inventory availability, data localization for a region, locale availability, product retail release date, product stock, product data completeness or the like. In some embodiments, data validation may include filtering and/or evaluating data against a user/navigational criteria, size, match other criteria. In some embodiments, Receive a navigational context 316 may provide an input to data validation 302.

Associate first metadata quality to group/category 304 determines a first metadata quality that can be associated with a product dimension. In some embodiments, multi-threaded asynchronous data processing means that 304, 308, 312 are not processed sequentially. In some embodiments, the association of a metadata quality to one or more group/category is provided in whole or part within the product data received during receive product data 300. As will be appreciated, within a set of data, hundreds, thousands or more metadata qualities associated with a group/category may be identified. Dimensions may be used in combination to respect user, system, or a combination result filtering.

A dimension may be a combination of multiple dimensions wherein the metadata associated matches more than one dimension criteria. In one embodiment, a depicted dimension represents a dimension wherein two or more characteristics are shared, the number of shared characteristics associated with one or more dimension may increase or decrease based on user engagement, for example. User engagement can be captured as user gestures, for examples. As a user navigates a PDN dimension, the logic of the overall dimension, combination of dimensions, and prioritized product depictions associated with one or more dimensions may shift to reflect implicit search criteria reflected in the user input. In some embodiments, dimension match criteria are dynamic and the thresholds to generate a dimension match may change based on the number of products within product data with metadata qualities associated with a group/category.

In some embodiments, product data includes renderings, video, and/or visual depictions of products which are processed in order to determine metadata qualities. For example, rendering/visual depictions may be interpreted to determine metadata qualities associated with the product. PDN generator 45 may include instructions to recognize metadata qualities associated with a product depiction, for example color, product type, logo type, logo placement, gender intention, pattern, size, fit, activity, and other characteristics may be calculated and/or extracted from product depictions independently of or in conjunction with other product metadata qualities.

Dimensions generated and provided in association with PDN system may describe a number of characteristics and combinations of characteristic associated with a product that are used to calculate the dimensions, combination of dimension, and/or prioritization of products within a dimension.

Examples of such group/categories associated with dimensions include: characteristics, attributes, product type, metadata, color, color attributes, color type, print, print type, fastener, fastener type, fabric, fabric type, product type classification, product type subclassification, apparel category, apparel subcategory, gender, gender intention, size, size range, size availability, regional availability, online availability within a region, release date of a product, release date range of a product, end release date of a product, end release date range of a product, associated age, associated age range, associated activity, associated activity type, style, style category, product line, product line subcategory, season, season subcategory, price, discount, special offer, special offer subcategory, special offer availability region, special offer availability expiration date, region, micro-region, macro-region, special offer criteria, member only product, discount, discount range, length, length range, cup-size intention, cup-size intention range, sleeve type, sleeve type range, layer classification, layer classification range, product feature type, product feature type category, garment feature type, garment feature type category, designer, designer group, manufacturer, manufacturer group, manufacture region, manufacture region group, environmental impact feature, environmental impact feature group, temperature classification, temperature range classification, new/used classification, wear condition classification, digital availability, best seller classification, local retail availability, preferred retail location availability, number of inventory available online, number of inventory available local retail, number of inventory available preferred retail location, delivery options, promotion options, associated to promotion, association to promotion subcategory, conversion metrics associated with a product, specific conversion analytics associated with a product. Wishlist metrics associated with a product, specific product return metrics associated with a product, combinations, and the like.

Apply associated dimension logic 306, applies logic specific to the group/category associated with the metadata quality. The PD/PDN model is used to determine logic associated with a dimension. Multiple systems of logic may be included for a dimension. For example, a product color category dimension may include logic determining product depictions associated with similar or contrasting attributes, primary color, detail color, complimentary colors, luminance, vibrancy, palette, color family, warmth/coldness, complexity of color combinations, or the like. For the purposes of example, an apparel category dimension would evaluate different criteria than a color category dimension. For example, an apparel category dimension may include logic associated with similar or contrasting, portion of the body covered, layer, gender intention, cup-size intention, sleeve length, temperature intention, activity intention, or the like.

In association with PDN generator 45 and PD/PDN model 62, similarly, associate second metadata quality to group/category 308 determines a second metadata quality that can be associated with a product dimension and Apply associated dimension logic 310 and Associate X metadata quality to group/category 312 determines a X metadata quality that can be associated with a product dimension and Apply associated dimension logic 314 may be performed for hundreds, thousands or more metadata qualities associated with a group/category may be identified within the product data and associated metadata. Dimensions may be defined in combination.

Receive a navigational context 316 receives a context which may be related to a user, device capacity, URL access and/or navigational context. In some embodiments, the navigational context may be received earlier in the process and be an input to data validation 302. In some embodiments, the navigational context includes such data as time of day, region, current temperature, current weather, associated with a specific user, device, GPS coordinate, or the like. Navigational context may also include generalized models and data related to user navigation. Generalized navigational context models may be based on users within a region, demographic, access time frame, purchase engagement criteria, membership level, the like, or combinations.

Define a focal product 318 may be based on a navigational context, user navigational path, search history, category/characteristics selection, a special offer, a promotion, general or demographically specific logic related to navigation, purchase history, wishlist history, or the like, associated with all users, a subset of users, a group of users, a specific user or the intersecting values associated with such measures. In one embodiment, the focal product is defined based on a product previously purchased by a user. For example, a recently purchased product, a recently shipped product, a recently delivered product, a product purchased, shipped, delivered within a duration. The dimensions associated with the focal product may complete an outfit with the purchased focal product, have a high conversion history associated with the focal product (calculated for example based on cart histories, purchase histories, wishlist histories, navigational histories, or the like) match the focal product, complement the focal product, complete the focal product, accessorize the focal product, or combinations. In one embodiment, the focal product is defined based on a unpurchased product of interest to a user, for example a previously viewed, previously wished for, previously added and removed from cart, previously added and removed from wishlist, or the like, product. In one embodiment the dimensions associated with the unpurchased product of interest to a user include products and/or variations of products that the user has previously purchased.

Determine dimensions to provide 320 may be based on product metadata available, default navigational contexts, user navigational contexts, retail context, VR/AR environment, specific characteristics of the focal product, specific characteristics of the user, user gestures, user engagement, user history, user purchases, user demographic, user demographic history, product sales history, product conversion history, access time frame, membership level, region, promotions, user wishlist, focal product data, inventory data, shared categories, shared category factors, shared attributes or qualities, or the like. In some embodiments, determine dimensions to provide 320 may involve determining a plurality of product dimensions. A dimension can be determined based on more that one category criteria. For example a dimension might show styles of women's pants available in one or more colours and one or more sizes that are on promotion, or other category set that combines hierarchy/characteristic metadata. A category ca be used to determine a dimension which can then be filtered further by, e.g. the axis logic to create a product grouping which represents the products which fall within the dimension based on their depictions.

Define first dimension priority logic 322 will assess a first dimension based on the focal product which will be displayed alongside the focal product. In some embodiments, priority logic is defined based on the dimension, the context in which the dimension is being depicted, conversion, user prior engagement with the dimension, other user metadata or the like. In some embodiments, a default dimension priority logic is applied. In some embodiments, the default dimension priority logic is modified and/or improved based on ML or AI improvements to the PD/PDN model.

Define second dimension priority logic 324 similarly defines a priority logic for a second dimension.

There are a minimum of two dimensions associated with a product, but there may be tens, hundreds, thousands, or more dimensions associated with a product and the data and metadata associated with the product.

Display first dimension, including focal product, on a first axis 326, the first dimension, including focal product, being displayed by the PDN UI 6 to the user through the output of the user device 10. In some embodiments, the output onto the user device of the first dimension, including focal product, on a first axis can occur through any one of a GUI, a virtual/augmented reality headset, touch screen, smart mirror, smart phone, computer, tablet, touchscreen kiosk, smart exercise device, fitness tracker or a connected fitness system.

Display second dimension, associated with the focal product, on a second axis 328, the second dimension being displayed being displayed by the PDN UI 6 to the user through the output of the user device 10. The second dimension, associated with the focal product, can be similarly displayed through the same outputs as the display first dimension, including focal product, on a first axis 32 mentioned above.

In some embodiments, the first dimension is displayed along a vertical axis and the second dimension is displayed along a horizontal axis. These axis orientations may be depicted in any manner such that the user can perceive the relationships between the focal product depiction and the first and second dimension. In some embodiments, a third, fourth, fifth or more dimensions are depicted. In particular, in AR/VR spatial representations have the capacity to depict a greater number of dimensions.

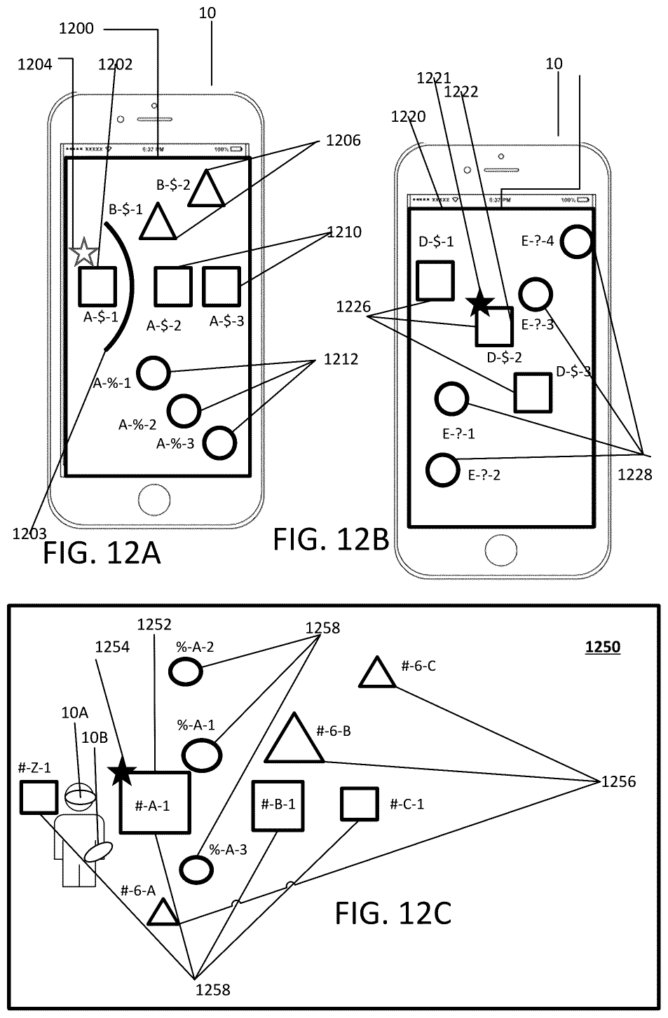

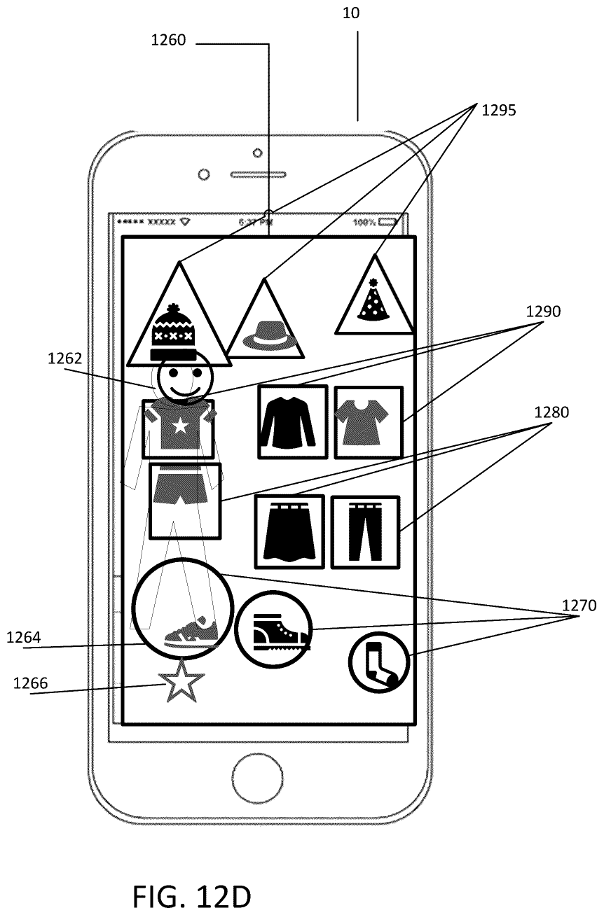

See FIG. 12A for a simple three dimension GUI example, and FIG. 12C for an AR/VR three dimension user interface.

Transmit control signals to one or more sensors 330 can involve the hardware processor 12 communicating with the one or more sensors to perform measurements (e.g., using sensors and cameras) relating to a user and user activity, user navigational intention, and/or an environment.

Receive user navigation input data 332 comprises receiving user navigational input provided through an input for example, the use of a touch screen, pointing device, camera evaluated gesture, VR or augmented reality glove, sensor, or other controller.

Evaluate user navigation first axis/second axis 334 determines the user input in relationship to one or more navigational axis. For example, a user may scroll down a vertical dimension, across a horizontal dimension, or access a third dimension.

Selective update of the focal product and/or first/second axis 336 can involve the hardware processor 12 receiving the Evaluate user navigation first axis/second axis 334 and communicating with the PDN 62 to selectively update the first/second axis or focal product based on Product Model 65, Context Model 65, Gesture Model 75 and user inputs such as user gestures, search terms and selection of a product, category or description. In some embodiments, only one of the focal product, first dimension and second dimension are updated based on a user input. In some embodiments, any combination of the focal product, first dimension and second dimension are updated based on a user input. In some embodiments, the PDN will update the first or second axis with a new dimension using the prioritization criteria established at the Define first dimension priority logic 322 and/or Define second dimension priority logic 324. The updated first and/or second dimension are selected based on a user and navigational metadata. In some embodiments, the focal product is updated based off of a user selection made through the user input device 10, in which the user selects a first or second dimension to become the updated focal product. In some embodiments, the focal product is updated based on the same inputs used at Define a focal product 318.

The updated focal product and/or first/second axis is displayed on the user device using a depiction which is sent to the PDN UI 6 from the PDN Generator 45. In some embodiments, if the focal product is replaced by a product dimension on the first or second axis, the product dimension will have an updated product depiction which can include a separate updated still image or video.

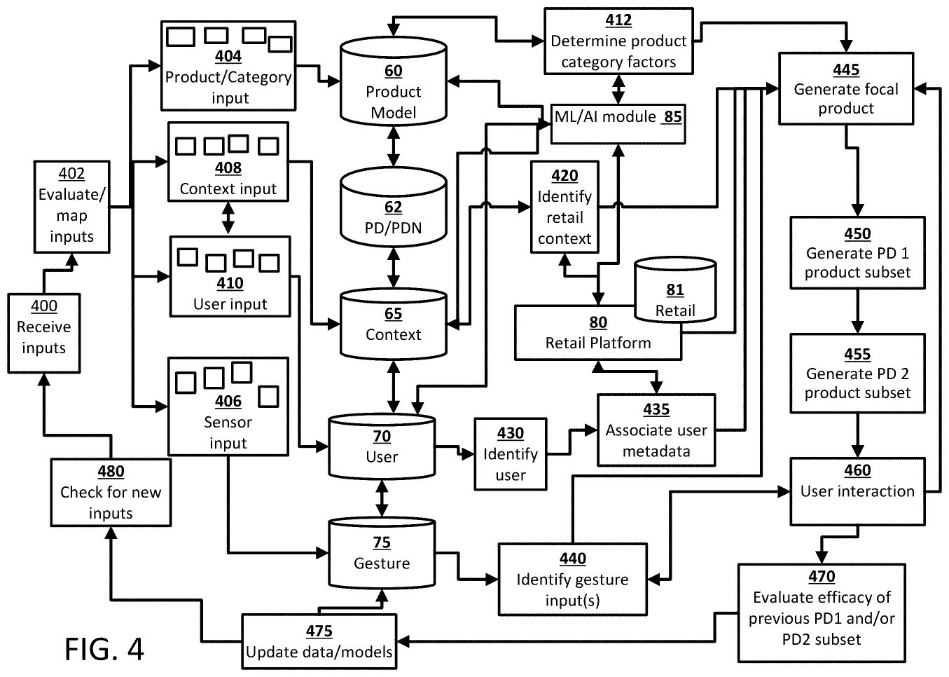

In various embodiments, the method in FIG. 4 may make use of machine learning types based on one or more of a combination of unsupervised, supervised, regression, classification, clustering, dimensionality reduction, ensemble methods, neural nets and deep learning, transfer learning, natural language processing, word embeddings, and reinforcement learning. Such machine learning may be performed using processes and evaluation tools such as K-Means Clustering, Hierarchical Clustering, Anomaly Detection, Principal Component Analysis, APriori Algorithm, Naïve Bayes Classifier, Decision Tree, Logistic Regression, Linear Regression, Regression Tree, K-Nearest Neighbour, AdaBoost, Markov Decision Processes, Linear Bellman Completeness, Policy Gradient, Asynchronous Advantage Actor-Critic (AC3), Trust Region Policy Optimization (TRPO), Proximal Policy Optimization (PPO), Deep Q Neural Network (DQN), C51, Distributional Reinforcement Learning with Quantile Regressions (QR-DQN), Hindsight Experience Replay (HER) and the like. In one embodiment, the machine learning is based on one or more of user feedback, user engagement, user purchases, user activity engagement, user engagement feedback, user physiological activity engagement, purchases resulting from a engagement, PDN representation type feedback, PDN representation type engagement, activity participation resulting from a PDN representation. Machine learning is a field of artificial intelligence. Machine learning can involve one or more machine learning models that learn and improve from data. Machine learning can involve training and testing models using training data and testing data. Machine learning and/or artificial intelligence can process data to make predictions, recommendations, and content using its models. Artificial intelligence can refer to computer systems that mimic human functions such as vision, learning, speech, pattern detection, and motion, for example.

FIG. 4 shows aspects of a method for generating and/or providing a two or more PD within a PDN associated with a focal product based on inputs characterizing a product, a context, and/or user input. In some embodiments, sensor input associated with user engagement is evaluated.

Input values and data models embodied in FIG. 4 are exemplary in nature. Data elements and steps may be omitted, re-ordered, and/or added without departing from the scope of the disclosure. In some embodiments, data models product 60, PD/PDN 62, context 65, user 70, gesture 75, retail 81, retail platform 80 are pre-populated and updated during aspects of the method of generating and/or providing PD/PDN. The FIG. 4 example expands on processing operations in FIG. 3 showing additional data access, update, and exchange including data models intercommunicable and related to steps in methods to generate and provide a PDN.

Receive inputs 400 includes receiving preprocessed, recorded, and streamed input or a combination. Streamed input comprises real time and near real time: sensor data, streamed video and/or images, audio recording data, augment reality data, virtual reality data, mixed reality data and/or a combination. Recorded input comprises sensor data, streamed video and/or images, augment reality data, virtual reality data, mixed reality data, and/or a combination. Such inputs can include and be augmented by user, application, and/or system inputs which provide additional related data such as a context, user ID, user type, user membership, activity, activity type, exercise activity ID, exercise platform ID, and the like. In some embodiments, recorded and streamed inputs are processed separately, and different analyses are applied based on the whether the input is a previously recorded or real time/near real time.

Evaluate/map inputs 402 identifies specific data related to product/category input 404, sensor input 406, context input 408, and user input 410 and associates the data with appropriate model/repository product 60, PD/PDN 62, context 65, user 70, gesture 75.

Product/Category Input 404 is provided in association with or through retail platform 80 and or retail model 81. In some embodiments, Product/Category Input 404 includes a combination of navigational and user inputs which can include specific characteristics of the user, user history, user purchases, user demographic, user demographic history, product sales history, product conversion history, access time frame, membership level, region, promotions, user wishlist.

Context input 408 can include data relating to both the users interaction and navigational history associated with PDN. The Context input is used by the Context Model 65 to Define a focal product 506. In some embodiments, context data includes data corresponding to the user navigation history such as identifying qualities such as retail purchases, navigation conversion, activity history, wishlist, content, wishlist history, cart content, cart history appropriate to PDN generation and/or evaluating engagement with PDN. In some embodiments, context data includes data relating to the manner in which the user is interacting with the PDN, such as through an online digital retail environment, participating within a smart mirror based activity (exercise class, training session, concert), a workout or wellness activity performed by an individual, a virtual reality context, a wellness recommendation system, an online social media environment, a retail environment, and/or using an application specifically for evaluating products and providing information about more than one product dimension. In some embodiments, input device 15 provides one or more elements of the context data.

User input 410, can include a token, ID, machine executable code, user authentication details, device metadata, location, activity or class associated with the user, activity type, class type, date, time, region, local weather and other regional factors, user device hardware details, system details, membership level details, user points or rating, user activity history, user purchase history, user navigational history, user preferences, file encryption standards, music, audio, lighting conditions, a combination thereof, and the like. In some embodiments, metadata related to the user may be retrieved from user model 70, context 65, gesture 75, retail platform 80, retail model 811, user device metadata 16 and the like based on an ID provided. In some embodiments, the user is provided with a method, such as a user interface (UI) in application 18 or navigational system in retail platform 80 in which they may select a product category, product characteristic, focal product and/or provide additional context information. In some embodiments, user data includes data related to other users of PDN system. In some embodiments, user data includes historical data associated with users and/or user navigation. In some embodiments, depersonalized data is provided. In some embodiments, user data provided may be generated based on an AI/ML model rather than specific human user behaviour.

Identify user 430 includes identifying contextual data associated with the user. These factors include one or more of a user, a user ID token, session ID, hardware capacities, software capacities, regions, encoding types, lighting, camera resolution, timestamps, exercise class context, workout context, membership level, user role, system hardware and other metadata associated with the input 400. In some embodiments, the input context identifies whether the user is a customer support person assisting another user. In some embodiments, context data 65 and or retail data models 81 are used to determine whether a user is engaging with the system during an in-person retail engagement, on behalf of another user, using a specific application, using a specific web portal, using a specific regional web portal, using a specific interaction kiosk or augmented reality environment, combinations, or the like.

The user model 70 may be updated with data associated with the user and/or engagement evaluations related to the user. In some embodiments user data related to user activity history, user preferences, user devices, user companion engagement response history, user companion history, user type, user preferences, user membership, user purchase history, user wellness history, and the like are associated with the user. Associate user metadata 435 associates additional data available in the system with the user input. In some embodiments, user metadata may include data generated by other users, or simulations of a specific user or types of users, with shared user characteristics.

Sensor input 406 includes the use of a touch screen, headset, input devices, voice navigation audio input, gesture detection sensors, and the like. A sensor can be an device that detects or measures a physical property (e.g., property of a material), records the detections or measurements, or transmits the detections or measurements. A sensor is a device that responds to a physical stimulus and generates a resulting measurement. A sensor can be a device, machine, or subsystem that detects events or changes in its environment, produces an output signal associated with sensing physical properties, and sends the information to other electronics, such as a hardware processor.

Sensors such as accelerometers, gyroscopes, Global Positioning System (GPS) sensors, camera sensors, video motion sensors, inertial sensors, IMU (inertial measurement unit) head tracker, Passive Infrared (PIR) sensors, active infrared sensors, Microwave (MW) sensors, area reflective sensors, lidar sensors, infrared spectrometry sensors, ultrasonic sensors, vibration sensors, echolocation sensors, proximity sensors, position sensors, inclinometer sensors, optical position sensors, laser displacement sensors, multimodal sensors, and the like may be used to make such measurements. A single sensor device may be used to measure both physiological engagement and movement.

The models in System 100 and 200 include User 70, PDN 62, Product Model 60, Context 65, Gesture 75, ML/AI Module 85 and Retail Model 81. The Models operate within Hardware Processor 13. Models can be of one or more type where the type includes one or more of including density-based, distribution-based, centroid based, k-NN (k-nearest neighbor), k-Means, DBSCAN (density-based spatial), hierarchical, Gaussian mixture model, BIRCH (balanced iterative reducing and clustering) method, or the like. The models can encode input data into a lower-dimensional representation of the input data, extract valuable information and reduce the dimensionality of data.

Product Model 60 is stored on Memory 13 and uses as an input a set of product data made up of two or more sets of metadata consisting of the characteristics and/or taxonomies associated with the product. Product Model 60 includes processor-executable instructions or processor-readable data which when executed cause Hardware Processor 13, to interpret a set of Product input 404 and determine metadata values associated with the product data. In some embodiments, Product Model 60 receives the product data from Product/Category input 404 and then depicts a product associated with the product data and identifies two or more metadata values associated with the product data. In some embodiments, the two or more metadata values can be associated with a product taxonomy, product characteristic or a combination of product taxonomy and product characteristic. In some embodiments, there can be more then two metadata values generated by the Product Model 60 for a single set of product data, such as in a VR/AR retail environment. In some embodiments, Product Model 60 is prepopulated with user metadata based on stored data of past engagement from groups of users having related context and navigational characteristics. The prepopulated metadata will be updated with metadata specific to the user based on the users engagement with the PDN.

PD/PDN 62 is a model which receives contextual inputs and product data in order to generate a group/category of products associated with metadata qualities. Within a group/category of products, each product may have two or more metadata characteristics which match a specific product dimension. In some embodiments, at least two categories of products will be generated, representing product dimensions in which within each product dimension there are one or more metadata qualities shared between all products within the group. The PD/PDN 62 will determine dimension logic that selects which product characteristics associated with the focal product should be prioritized, the dimension logic will vary based on the categories included in the dimension. For example, a product color category dimension may include logic determining product depictions associated with similar or contrasting, primary color, detail color, complimentary colors, luminance, vibrancy, palette, color family, warmth/coldness, complexity of color combinations, or the like. For the purposes of example, an apparel category dimension can evaluate different criteria than a color category dimension. For example, an apparel category dimension may include logic associated with similar or contrasting, portion of the body covered, layer, gender intention, cup-size intention, sleeve length, temperature intention, activity intention, or the like. In some embodiments, PDN/PD 62 is prepopulated with user metadata based on stored data of past engagement from groups of users having related context and navigational characteristics. The prepopulated metadata will be updated with metadata specific to the user based on the users engagement with the PDN.

Context 65 includes processor-executable instructions or processor-readable data which when executed cause Hardware Processor 13, to interpret a set of Context Input 408 and determine the environment in which the user is interacting with the Retail Platform 80. In some embodiments, Context 65 is prepopulated with user metadata based on stored data of past engagement from groups of users having related context and navigational characteristics. The prepopulated metadata will be updated with metadata specific to the user based on the users engagement with the PDN. In some embodiments, user metadata will be retrieved by the Context 65, and provided by the Context 65 to the User 70, Gesture 75, Retail Platform 80, Retail Model 81, user device metadata 16 and the like based on a user ID.

User 70 is a model that stores information which establishes a navigational context to be used to define a focal product and product category factors. User 70 includes processor-executable instructions or processor-readable data which when executed cause Hardware Processor 13, to interpret a set of User input 406 and determine the user profile that is interacting with the Retail Platform 80. In some embodiments, the User 70 will receive metadata from User Input 410, Context 65, Product Model 60 and Gesture 75 to establish a navigational profile of the user based on their past and current interactions with the PDN. In other embodiments, the User 70 will provide the ML/AI module 85 with stored navigational metadata from the user, and the ML/AI module 85 will provide a simulated profile of a user, or types of users, with shared user characteristics. In some embodiments, the User 70 will track updates in user inputs and compare the updated information with stored information, and providing this information to the PDN 62 which will be used to update the first and second axis products and/or focal products. In some embodiments, User 70 is prepopulated with user metadata based on stored data of past engagement from groups of users having related context and navigational characteristics. The prepopulated metadata will be updated with metadata specific to the user based on the users engagement with the PDN. In some embodiments, user metadata will be retrieved by the User 70, and provided by the User 70 to the Context 65, Gesture 75, Retail Platform 80 and Retail Model 81, user device metadata 16 and the like based on a user ID.

Gesture 75 is a model which stores data relating to the potential gesture inputs performed by the user through the user device 10. Gesture 75 can be from a model used to determine in what context the user is interacting with the GUI, and which sensor inputs should be used to asses potential user gestures. Gesture 75 includes processor-executable instructions or processor-readable data which when executed cause hardware processor 13, to interpret a set of Sensor input 406 and assess user engagement with the PDN UI 6 based on sensor inputs at User Device 10. Gesture 75 receives context and navigational data to determine how the user can interact with the PDN UI 6 based on potential input devices connected to the user device 10. For example, the Gesture 75 will receive inputs from the sensor input 406, User 70 and Context 65 to assess whether the user is interacting with the User Device 10 through a touch screen, VR/AR glove, controller, pointing device, camera evaluated gesture, sensor, or other controller. Based on the environment in which the user is interacting with the PDN UI 6, Gesture 75 will determine which gestures could be a potential input from the user and send a signal to certain sensors to measure inputs which are relevant to the context in which the user is interacting the PDN UI 6. In some embodiments, Gesture 75 is prepopulated with user metadata based on stored data of past engagement from groups of users having related context and navigational characteristics. The prepopulated metadata will be updated with metadata specific to the user based on the users engagement with the PDN. In some embodiments, user metadata will be retrieved by the Gesture 75, and provided by the Gesture 75 to the User 70, Context 65, Retail Platform 80, Retail Model 81, user device metadata 16 and the like based on a user ID.

Retail Platform 80, being directly or indirectly coupled to Retail 81, provides access to the user to one or more regional or global retail platforms. Retail 81 is a database which stores product information specific to a regional or global retail location. In some embodiments, upon a user interacting with the PDN 62 through engagement with the PDN UI 6, the Retail Platform 80 will access location specific product data such as regional availability, inventory availability, data localization for a region, locale availability, product retail release date, product stock, product data completeness or the like. In some embodiments, Retail Platform 80 may be contemporaneously accessed by users across one or all regional and global platforms. In some embodiments, Retail Platform 80 is configured as a product management system which can generate product information. In a further embodiment, the product information generated by the Retail Platform 80 is sent through a messaging system component of Retail Platform 80 to User Device 10 through one or more of email, SMS message, MMS message, social media notification or notification message. Retail Platform 80 can be an application accessed by the user device 10 when interacting with an online retail shopping environment. Retail 81 can be the data relating to product information stored for regional and global retail platforms. Retail platform 80 accesses retail 81 in order to determine things such as availability and offers for products that the user might be interested in.

In some embodiments, Retail 81 will receive navigation metadata from the User Input 410 and Identify Retail Context 420, and upon accessing the product information stored in Retail 81, will provide information concerning products, product dimensions, product dimensions, product engagement, retail, inventory and/or user engagement responses that will be used in Generating Focal Product 445. In some embodiments, PDN 62 is stored on Retail Platform 80, and Retail Platform 80 is used to provide PDN UI 6 through User Device 10. Retail Platform 80 receives navigational inputs from the user through the PDN UI 6 such as selection of a product category, product characteristic, focal product and/or additional context information which is used to generate product categories and/or focal product. In some embodiments, Retail Platform 80 and Retail Model 81 are prepopulated with user metadata based on stored data of past engagement from groups of users having related context and navigational characteristics. The prepopulated metadata will be updated with metadata specific to the user based on the users engagement with the PDN. In some embodiments, user metadata will be retrieved by Retail Platform 80 and Retail Model 81, and provided by the Retail Platform 80 and Retail Model 81 to the User 70, Context 65, Gesture 75, user device metadata 16 and the like based on a user ID.

Determine Product Category Factors 412 sets the categories that will be associated with the axis logic. The Determine Product Category Factors 412 will take the metadata values identified by the Product Model 60 and generate a category factor for each metadata value. In one embodiment, the Product Model 60 will generate two or more metadata values and the Determine Product Category Factors 412 will generate two or more product category factors. In some embodiments, the Determine Product Category Factors 412 is updated by the ML/AI Module 85 using generated product data and user data based on an AI/ML model rather than human user behaviour. A product category factor will be a variable associated with the product taxonomy, product characteristic or a combination of product taxonomy and product characteristic which is associated with the metadata provided by the Product Model 60. The product category factors will be generated to allow products to be grouped into dimensions based on shared product category factors. In some embodiments, product category factors can be assembled into a sequence in which all products sharing the same product category factor for a specific sequence value (i.e. the second sequence value being X) will share the product characteristic represented by that sequence value (i.e. colour, style, coverage, size).

ML/AI Module 85 is a predictive computer model which uses product and user datasets to provide one or more of the PDN 62, user model 70, context 65, gesture 75, retail platform 80, retail model 81 and user device metadata 16 with user metadata, context metadata and product metadata. In some embodiments, the user and context metadata generated by the ML/AI Module 85 for the user model 70, context 65, gesture 75, retail platform 80, retail model 81 and user device metadata 16 may include simulations of a specific user or types of users, with shared user characteristics. In some embodiments, the ML/AI Module 85 will update dimension logic and priority logic to improve the PDN 62 and PDN UI 6. In some embodiments, the updated dimension logic and priority logic generated by the ML/AI Module 85 is used to improve product exploration and product purchase conversions. In some embodiments, the ML/AI Module 85 training datasets include data relating to user feedback, user engagement, user purchases, user activity engagement, user engagement feedback, user physiological activity engagement, purchases resulting from an engagement, PDN representation type feedback, PDN representation type engagement, activity participation resulting from a PDN representation.

Identify retail context 420 will determine the environment in which the user is interacting with the PDN 62. In some embodiments, the retail environments include an online digital retail environment, participating within a smart mirror based activity (exercise class, training session, concert), a workout or wellness activity performed by an individual, a virtual reality context, a wellness recommendation system, an online social media environment, a retail environment, and/or using an application specifically for evaluating products. In some embodiments, the Identify retail context 420 receives context metadata from Context 65 and Retail Platform 80. In some embodiments, the ML/AI Module 85 can be trained to identify or update the retail context based on input from the Retail Platform 80 and Context 65.

Identify gesture input(s) 440 generates navigational metadata based on the inputs detected by Sensor input 406 and filtered by Gesture 75. In some embodiments, Identify gesture input(s) 440 provides an input to Generate focal product 445 in order to generate an initial focal product. In some embodiments, after an initial focal product is generated, Identify gesture input(s) 440 will provide input to User interaction 460 to update the focal product based on the navigation metadata received by Sensor input 406. In some embodiments, Identify gesture input(s) 440 will evaluate engagement associated with a user's activity based on the navigational metadata supplied by Gesture 75. In some embodiments, evaluating engagement associated with the user's activity requires the Identify gesture input(s) 440 to determine when a user's interaction with the PDN 62 involves an input related to a product depiction.

Generate focal product 445 determines a focal product to depict on the GUI UI 6 based on navigational context data, product data and user input. In some embodiments, Generate focal product 445 will select an initial focal product based on user engagement with a product depiction displayed on a GUI. In some embodiments, Generate focal product 445 will select a focal product based on a navigational context, user navigational path, search history, category/characteristics selection, a special offer, a promotion, general or demographically specific logic related to navigation, purchase history, wishlist history, or the like, associated with all users, a subset of users, a group of users, a specific user or the intersecting values associated with such measures. In some embodiments, different logic will be used by Generate focal product 445 to select a focal product depending on the user gesture or navigational metadata which initiates the users interaction with the PDN 62. As an example, a user may initiate the interaction with the PDN 62 by viewing a depiction of Product A in the Retail Platform 80, and upon selecting the product depiction and launching a PDN exploration associated with product A, Generate focal product 445 will receive the user inputs and navigational data, and select Product A to be the initial focal product. In some embodiments, Generate focal product 445 will update an initial focal product with a new product based on a users navigational inputs. In some embodiments, when updating the focal product, the user navigational input is received from User interaction 460 and includes a user gesture or input such as a search term or selection of a product, category, or descriptor.

Generate PD 1 product subset 450 can select a first product dimension associated with the focal product. In some embodiments, Generate PD 1 product subset 450 can be an application stored on server 20. The first product dimension will have a logical relationship with the focal product, such that one or more dimension characteristics of the first product dimension and the focal product dimension will match, complement, contrast or the like. Once a first product dimension is generated, Generate PD 1 product subset 450 will use product metadata from Product Model 60 and create a first grouping of products which match the first product dimension. Generate PD 1 subset 450 will run a prioritization logic on the first grouping of products to determine a first product depiction sent to the PDN UI 6. In some embodiments, prioritization logic will include assessing product metadata availability, default navigational contexts, user navigational contexts, specific characteristics of the focal product, specific characteristics of the user, user history, user purchases, user demographic, user demographic history, product sales history, product conversion history, access time frame, membership level, region, promotions, user wishlist or the like.

Generate PD 2 product subset 455 can perform similar functionality as Generate PD 1 subset 450 except it will produce a second, and distinct, product dimension which will be associated with the focal product. In some embodiments, Generate PD 2 product subset 455 can be an application stored on server 20. The second product dimension will be logically related to the focal product through one or more dimension characteristics that differ from the dimension characteristics associated with the first product dimension. Generate PD 2 product subset 455 will generate a second grouping of products. The second grouping of products will be put through a second prioritization logic to determine a second product depiction sent to the PDN UI 6. In some embodiments, the prioritization logic used for the first and second product groupings are the same. In another embodiments, the prioritization logic used for the first and second product groupings are different and can vary based on dimension characteristics. In some embodiments, more then two product dimensions are displayed on User Device 10, such that there is a third or more product dimensions generated. This can occur if the user is engaging with User Device 10 through a AR/VR retail context.

User interaction 460 will determine whether, after the focal product and product dimensions (at step 445, 450 and 455) have been generated, the user has made an input through User Device 10. If Identify gesture input(s) 440 sends a signal that a navigational input has been made by the user impacting the focal product or first or second dimension, then User interaction 460 will signal to update the product depictions and/or dimensions. In some embodiments, User Interaction 460 will signal Generate focal product 445 to update the focal product. In some embodiments, User interaction 460 will signal that a focal product update is needed if there is a user input explicitly selecting the first or second dimension, a search input or the like. If the focal product is updated, then the Generate PD 1 product subset 250 and Generate PD 2 product subset 455 will generate a new dimension associated with the new focal product generated. In some embodiments, User Interaction 460 will signal Generate PD 1 product subset 450 and/or Generate PD 2 product subset 455 to update the first and/or second dimension and/or logic. In some embodiments, User Interaction 460 will signal Generate PD 1 product subset 450 and/or Generate PD 2 product subset 455 to update the first and/or second dimension depiction but maintaining the same dimension characteristics and logic.

Evaluate efficacy of previous PD1 and/or PD2 subset 470 is a function that determines how well the first and second dimension drives user engagement with the PDN UI 6. In some embodiments, Evaluate efficacy of previous PD1 and/or PD2 subset 470 will evaluate user feedback, user engagement, user purchases, user engagement activity, user physiological activity engagement, purchases resulting from an engagement, PDN representation type feedback, PDN representation type engagement, activity participation resulting from a PDN representation. Depending on the level of user engagement with the PDN UI 6, the number of shared characteristics associated with one or more dimension may increase or decrease. In some embodiments, Evaluate efficacy of previous PD 1 and/or PD2 subset 470 will evaluate user engagement through a preferred engagement-activity interrelation, assigning points to an engagement-activity interrelation, a combination, or the like.

Update data/models 475 updates one or more of the data models and user metadata, with values associated with the user engagement with the PD, product subsets associated with the focal product, PD, PDN, and conversion, sharing, selecting, viewing, clicking on, engagement durations, or other specific user engagement metrics associated with the PDN provided.

Check for new inputs 480 is indicative of the ongoing receiving of product, user, sensor and other data. When receiving inputs where the context input 408 and user input 410 have not changed, identification processes such as 420, 430, 440 and association processes such 435 may be omitted in some embodiments.

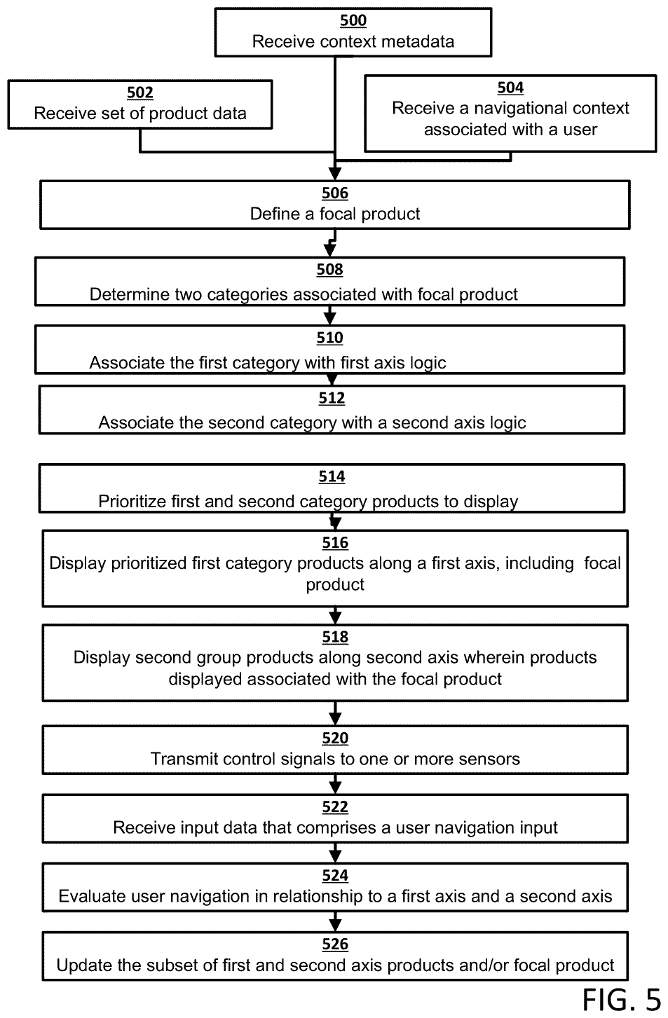

Turning to FIG. 5, in accordance with some embodiments, there is a method of generating output instructions for product navigation. In some embodiments, the output instructions are executable to generate visual elements relating to product navigation. In some embodiments, the output instructions will be displayed through the graphical user interface of a user device and the output instructions can automatically update the graphical user interface with one or more visual elements relating to product navigation. In another embodiment, the output instructions will be displayed through a VR/AR environment and the output instructions can automatically trigger the display of one or more visual elements in the VR/AR environment relating to product navigation. In some embodiments, the method of FIG. 5 is performed by Processor 13.

The method can involve generating output instructions for PDN. In some embodiments, generating can involve creating, constructing, computing or producing output instructions using e.g. data collection, transformation and processing. For example, sensors performing measurements can capture input data representing physical elements (e.g. user gestures) as part of a data collection process, and the input data can be processed and transformed with other data to generate the output instructions. In some embodiments, the output instructions can then be provided or made available to hardware components or devices, such as by transmission to the hardware components or devices and/or storing on a memory accessible by the hardware components or devices so that the output instructions are accessible by the hardware components or devices. In some embodiments, the output instructions can include code that automatically updates an interface 14 of a user device 10. The interface 14 can be one of GUI, TUI, NUI, AR, VR, Mixed Reality, or a combination thereof.

Receive context metadata 500, context metadata is one or more of device capacity, a language, a region, a date, a time, a device display size, a size of a window displayed on a device, a processor speed, a Wi-Fi or data connection capacity, a device type. The context metadata will be used to create a user identity and determine the retail environment for the user which will allow Product Model 60 and Context Model 65 to provide which will be used at Define a focal product 506 to generate a focal product.

Receive set of product data 502 comprises receiving, using at least one hardware processor a set of product data defining two or more products (e.g. a plurality of products) wherein in the set of product data, elements associated with a product provide, one or more product depiction associated with the product; two or more metadata values wherein the first metadata value comprises one of a value associated with a product taxonomy, a product characteristic, a combination of product taxonomy and product characteristic associated with the product and the second metadata value comprises one of a value associated with a product taxonomy, a product characteristic, a combination of product taxonomy and product characteristic associated with the product. In some embodiments, product data is integrated within retail model 81.

Receive a navigational context 504 receives a context which may be related to a user, device capacity, URL access and/or navigational context. In some embodiments, the navigational context includes such data as time of day, region, current temperature, current weather, associated with a specific user, device, GPS coordinate, or the like. Navigational context may also include generalized models and data related to user navigation. Generalized navigational context models may be based on users within a region, demographic, access time frame, purchase engagement criteria, membership level, the like, or combinations.

Define a focal product 506 uses a combination of the product data, navigational metadata and context metadata to determine a focal product. Define a focal product 506 is performed by Processor 12. In some embodiments, the navigation data is received from Gesture 75 and User 70, the context data is received from Context 65, and the product data is received from Product Model 60. In embodiments, Define a focal product 506 will be generated based on an explicit user input received through Gesture 75, such as selecting a product depiction provided through the Retail Platform 80. In some embodiments, Define a focal product 506 will use the product data and at least one of the context metadata or navigational metadata. In some embodiments, the Product data will provide at least two depictions of the focal product. In some embodiments, Processor 12 will use simulated metadata from ML/AI Module 85 in order to complete Define a focal product 506. In some embodiments, the focal product is more then one product, such as a group or set of products sharing a set of characteristics. In some embodiments, Define a focal product 506 is based on the same inputs as Define a focal product 318, such as a navigational context, user navigational path, search history, category/characteristics selection, a special offer, a promotion, general or demographically specific logic related to navigation, purchase history, wishlist history, or the like, associated with all users, a subset of users, a group of users, a specific user or the intersecting values associated with such measures.

Determine two categories associated with focal product 508 generates categories based on the product metadata of the focal product which will be depicted within the PDN 62. A category is determined by selecting one or a set of product metadata value(s) associated with the focal product, with the focal product metadata value representing a product characteristic, taxonomy or combination of both. In some embodiments, the metadata values associated with the focal product can themselves be associated with a hierarchy or characteristic associated with the product. These hierarchies/characteristics and groupings of value sets within and between them can be used to define categories. The navigational context may be a factor in which categories are highest values to depict within a PDN. As an example, a category can be “hiking pants” which could be defined by a set of product metadata values representing a characteristic, taxonomy, or combination of both, such that any product falling within the set of product metadata values would be included in the “hiking pants” category. The two categories selected will be used to form a dimension associated with the focal product. As an example, based on the Metadata of the focal product 508, the two categories selected based on their association with the focal product can be “activity type” and “colour”, which would create dimensions composed of those two categories. In some embodiments, Determine two categories associated with focal product 508 may generate more then two categories, and as a consequence a dimension will be composed of a string of more then two categories. In some embodiments, the categories are selected based on categories that will achieve a higher conversion likelihood using context and navigational metadata of the user and past users. In some embodiments, navigational context metadata will be used by the PDN 62 to determine which categories should be depicted on the PDN UI 6.

The complexity of the metadata associated with the focal product can vary, within a set of product data there can be, hundreds, thousands or more metadata qualities associated with an identified category.

Associate the first category with a first axis logic 510 generates, through the PD/PDN model 62, one or more sets of first axis logic which creates a first dimension composed of a category, or set of categories, having a logical relationship with the focal product. The first axis logic will associate the category with the focal product metadata through matching, contrasting or complementing values, and will map products which share the characteristics of the first category to create a first grouping of products. As an example, a first dimension may be composed of a sequence of categories (activity type-colour-promotion), and the first axis logic attaches to each value in the sequence a logical relationship associated with the focal product metadata (same activity type-contrasting colour-same promotion). In some embodiments, the first grouping of products are represented by product depictions from Receive set of Product data 502. For example, if Determine two categories associated with focal product 508 generates categories of “colour” and “collar style”, then a first grouping of products may be depicted having product dimensions that match the colour of the focal product but contrast the collar style.

Associate the second category with a second axis logic 512 performs the same function as 510 but uses a category, or set of categories, associated with the focal product and generate a second dimension including a second grouping of products. In some embodiments, more then two sets of axis logic may be defined, such that more then two categories associated with the focal product can be used for a first or second grouping of products.

Prioritize first and second category products to display 514, comprises the PD/PDN model 62 using a prioritization logic to order the depictions of products within a first or second product grouping. Inputs for the prioritization logic include Context input 408, User input 410, and Sensor input 406. In some embodiments, as the user engages with the PDN UI 6, the prioritization logic will update the order of the product depictions based on user inputs such as search inputs, category selection or product selection. In some embodiments, ML/AI module 85 can be trained on datasets to determine prioritization logic.

In some embodiments, the prioritization logic may vary between categories. As an example, the prioritization logic may prioritize the depiction of a product on the first axis based on the popularity of the product within the category, the product which is a closest color match to the focal product, similarity of the product activity category to the focal product, data indicating previous users who bought the focal product were likely to purchase a product in a complimentary category, promotions on certain products, products which were released during a similar time-frame, a product which can be worn alongside the focal product, or the like.

Display prioritized first category products along a first axis, including focal product 516 will display on User Device 10 a PDN in which a depiction of the focal product and prioritized first category products will be displayed along an axis in a manner that drives user engagement. In some embodiments, the first axis can be the vertical axis (i.e. column-oriented) of the display. In some embodiments, the focal product will have multiple depictions and/or a video. Display second group products along second axis wherein products depictions associated with the focal product 518 will display on User Device 10 a GUI in which a depiction of the prioritized second category products will be displayed opposite the first axis in a manner that drives user engagement. In some embodiments, more than one product from either the first or second prioritized categories will be displayed on the GUI. In some embodiments, PDN Generator 45 will generate the product depictions that are displayed on User Device 10.

Transmit control signals to one or more sensor 520 comprises the hardware processor 12 communicating with the one or more sensors to perform measurements (e.g., using sensors and cameras) relating to a user and user activity, user navigational intention, and/or an retail environment.

Receive input data that comprises a user navigation input 522, user navigation input includes a user gesture which can be received through the use of a touch screen, pointing device, camera evaluated gesture, VR or augmented reality glove, sensor, or other controller. The input data will be comprised of a user gesture with the PDN UI 6. In some embodiments, Receive input data that comprises a user navigation input 522 is performed by Gesture 75 and User 70.

Evaluate user navigation in relationship to a first axis and a second axis 524, the user navigation input is plotted along the first axis and second axis to determine user intention. As an example, a user may swipe on the depiction of the first axis product in a direction that is away from the focal product, Gesture 75 will receive this input and determine that the intention was to remove the first axis product and replace it with a new option. In some embodiments, more then two axis are present such as in a VR/AR retail environment.

Update the subset of first and second axis products and/or focal product 526, comprises the hardware processor 12 receiving the Evaluate user navigation in relationship to a first axis/second axis 334 and communicating with the Product Model 60, PDN 62, Context 65, User 70 and Gesture 75 to update the axis or focal product based on the input by the user. In some embodiments, only one of the focal product, first dimension and second dimension are updated based on a single user gesture. In some embodiments, any combination of the focal product, first dimension and second dimension are updated based on a single user gesture. In some embodiments, hardware processor 13 will update the first or second axis with a new product using a new prioritization logic than initially used for the original focal product at Prioritize first and second category products to display 514. In some embodiments, the focal product is updated based off of a user selection made through the User Device 10, in which the user selects a first or second dimension to become the updated focal product. In some embodiments, if a new focal product is selected, the first and second axis products or the first and second dimensions may be automatically updated to reflect the change in focal product.

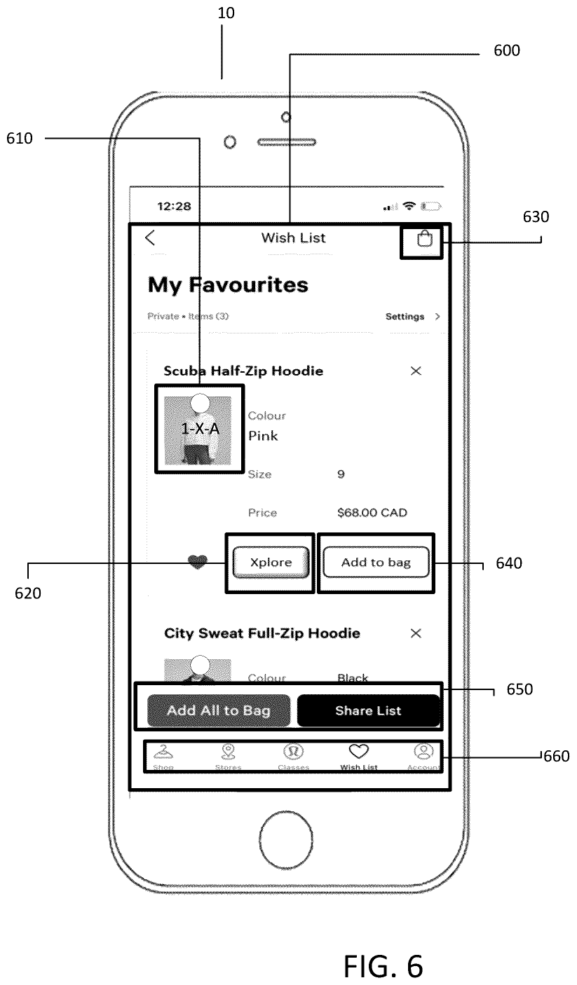

Turning to FIG. 6, an example user interface associated with PDN embodiments is provided. There are many visualization techniques associated with providing a focal product and two or more navigational dimensions associated with a focal product, and this user interface is provided as an example.

User device 10, displays GUI 600 which is associated with application 18. GUI 600 may be part of a retail application, retail website, customer support tool, inventory management tool, workout application or the like. In this example, a wishlist component is displayed in GUI 600, the wishlist is composed of products selected by a user or proposed to a user and there may be one or more product depictions. Similarly, cart and general retail navigation may provide such a context from which product dimension navigation may be triggered. In various embodiments, GUI 600 can also refer to visual elements of an AR or VR environment.

In GUI 600, PDN UI 6 is launched through an interaction with GUI element 620. This interaction may be a click, tap, combination of taps, gesture, swipe or the like. In some embodiments, interactions with product depiction 610 may launch PDN UI 6. In some embodiments, PDN UI 6 is displayed by default and/or a standard view during search which may be launched based on user interactions, user engagement criteria, user metadata, user preference, or the like. The context from which PDN UI 6 is launched may include other functionality such as, by example, UI bag action 630, Add to Bag/Share List controls 650, and or standard application toolbars 660.

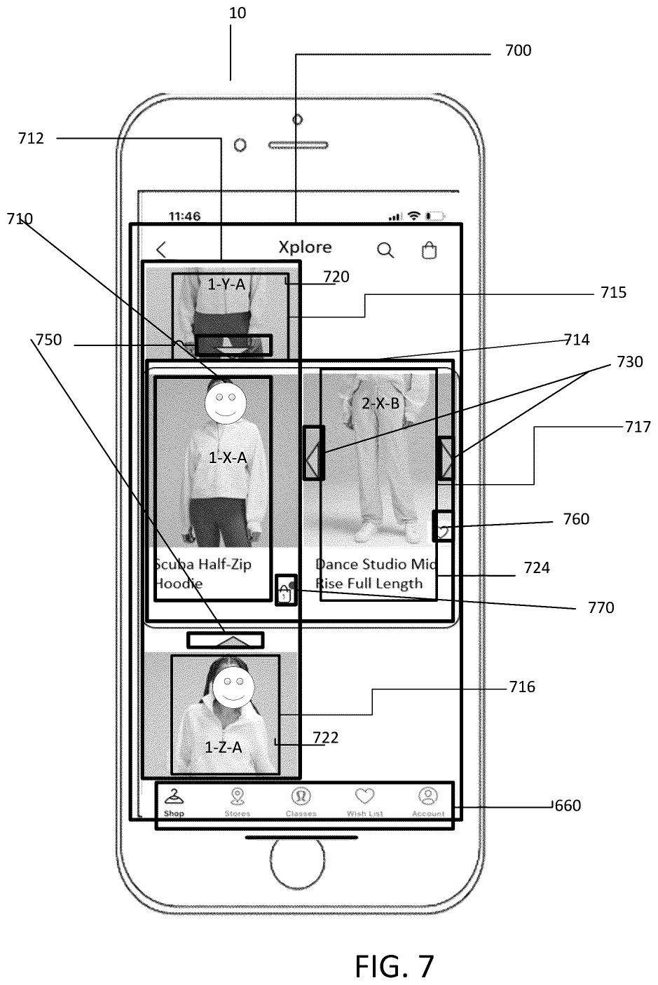

FIG. 7 shows an example PDN UI 700 such as might be launched by element 620 in FIG. 6 on user device 10 or through other means.

Focal product depiction 710 may be in a number of different formats including one or more of locations in user interface, size, outline, visual indicators, color and/or color intensity, background color, visual flags, providing a different depiction format for focal product than non-focal products displayed (for example focal product depiction provided is a video, non-focal products are still images) and the like.

Focal product may be depicted as a single product or a group of products.

In example PDN UI 700, focal product 710 depicts an example garment (e.g. Scuba half-zip hoodie) with dimension characteristics 1-X-A provided for the purpose of clarifying embodiments associated with dimension logic. A first dimension, displaying a prioritized product within that first dimension 712, is displayed vertically along an axis in column and a second dimension 714, displaying one or more prioritized product(s) within that second dimension 714, is displayed horizontally along a row. Focal product 710 intersects with the first dimension depiction 712 and the second dimension depiction 714.

Product depiction 717 displays the second axis product dimension on the PDN UI 700, Product depiction 715 and 716 display the first axis product dimension on the PDN UI 700. In some embodiments, more then one product can be depicted on the PDN UI 700 for both the first and the second product dimensions. Product depictions 715, 716 and 717 displays the product depictions through the PDN Generator 45 which is provided with the depictions by Model 60. In some embodiments, an update to the focal product will cause the PDN Generator 45 to select a different product depiction to be displayed based on past user engagement metrics. Product name 724 is displayed below product depiction 717 and focal product 710, the product name can be displayed in a number of different formats such location compared to the depiction, font size and product detail. In some embodiments, product name 724 is provided for all product dimensions.

In some embodiments, PDN UI 700 includes additional controls such as vertical scrollers 750 and horizontal scrollers 730. In some embodiments, these scrollers are used to navigate one or more of additional prioritized product depictions associated with the dimension, replacement of the focal product with a different product associated with the dimension. Additional controls, for example, such as shopping bag 770 and wishlist 770 may enable the user to access additional functions from the PDN UI 6 and this functionality may be associated with an action being performed related to a specific product associated with a specific product dimension depiction where the product may or may not be the focal product within PDN UI 700. In some embodiments, Favourite 760 may be a function available for all product dimensions, Favourite 760 will allow a user to add a product dimension to their wishlist 770 which they can then view later.

Various logic can be used to determine the focal product to provide. In this example the user initially engaged with a product depiction associated with the focal product in the wishlist GUI and launched a PDN exploration associated with that product.

The axis logic is used to determine which dimensions to display. The axis logic uses product metadata to break a product down to an sequence of dimension characteristics, with each dimension characteristics representing a category composed of a characteristic, taxonomy or combination of both. The axis logic creates product dimensions in which each dimension characteristics has an association with the focal product. As an example, the first axis logic in FIG. 7 contains a grouping of products associated with the 1 type product category (1-Y-A, 1-X-A, 1-Z-A). In this example, the first category is coverage type, and is set as “1”, representing an upper body covering and “2” representing a lower body covering, however, in another example the first product category can be a general or specific category such as brand, sleeve length, size, or the like. The second category in this example indicates a color category, with Y, X and Z representing a different product colour. The third category in this example indicates a category associated with a colour shading characteristic, with all products in the first axis having a matching “A” value. In further embodiments, the third category could be a more specific category associated with colour (i.e. shade, popularity, complementary colours, undertone) or coverage type, or can be a distinct category unrelated to the first two categories. As can be seen from the example, the first axis logic has product depictions having a match for the first and third categories, with a varying second category. The second axis logic has product depictions that match the second dimension category, and have a different first category (“2” being lower body coverings) while the third category may or may not match the focal product.

All or a portion of these categories may be associated with metadata associated with the product. In some embodiments, some of the metadata characteristics (color, apparel type, secondary color characteristics) may be derived from images representing interpretation of the product depiction itself using image analytics.

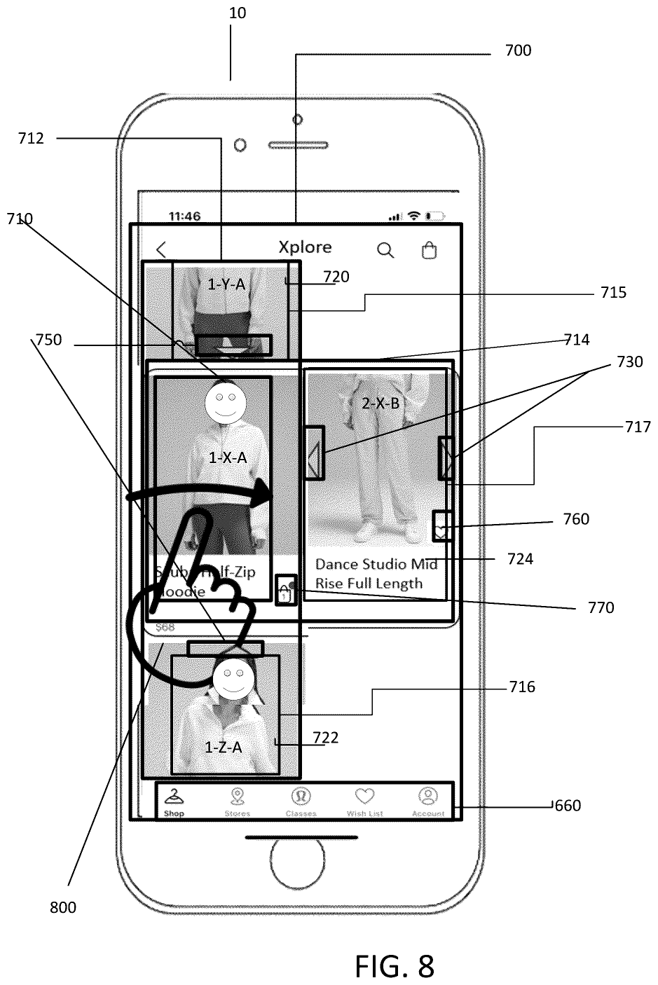

FIG. 8 shows an example PDN UI 700 being interacted with through user input/gesture 800 where the user swipes along the second axis 714.

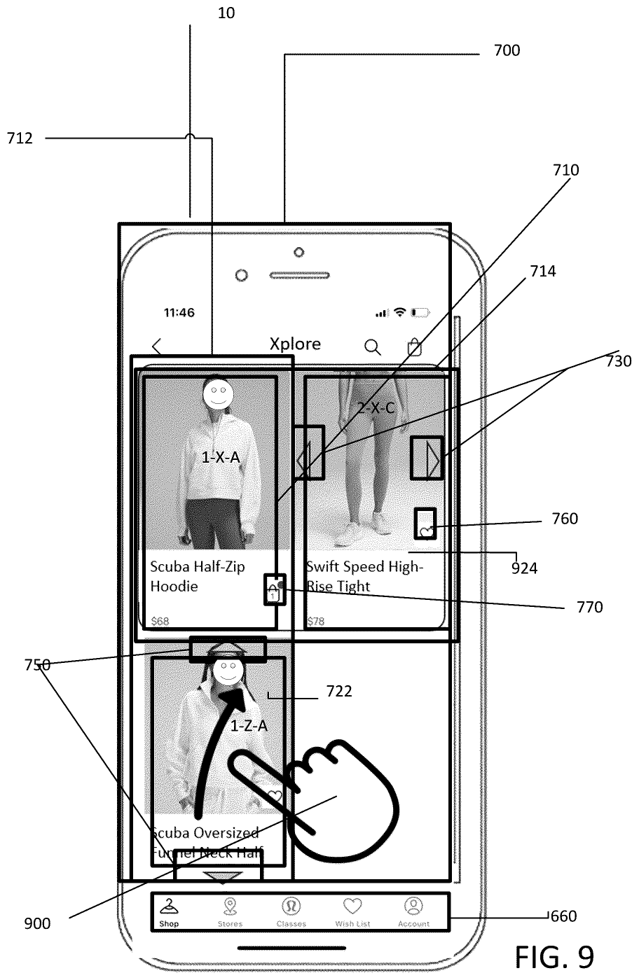

The user input/gesture 800 will be received by sensor input 406 and using Gesture 75, the hardware processor 13 will identify the user's interaction with the GUI and generate a response on the PDN UI 700. In the current example, the user has swiped horizontally along the second axis, which would be identified in Gesture 75 to represent an intention to replace the second dimension depiction with a new product. The second dimension depiction is replaced, as seen in FIG. 9, with a new dimension of 2-X-C, wherein the second dimension depiction still shares two categories with the focal product but the last product category has been changed to provide a new dimension for the user to engage with. In the current example, the first dimension and focal product depictions remain the same as user input/gesture 800 was directed solely to the second dimension.

In some embodiments, the user input/gesture 800 could be communicated to the PDN UI 700 through the horizontal scroller 730.

FIG. 9 shows the updated PDN UI 700 after receiving user input/gesture 800, a new user input/gesture 900 moves non-focal product on the first dimension to focal product position.

User input/gesture 900 is a vertical swipe which would command the PDN UI 700 to update to replace the focal product with the first dimension product depiction. In some embodiments, when a product depiction along the first or second axis becomes the focal product, an updated depiction, or updated type of depiction, will be provided to the user. For example, the updated depiction or type of depiction for the updated focal product can include a larger display, full model image, a new model pose, a video clip, audio file, interactive media, a rotating product view, or the like.

The first dimension 712 is displayed along the first axis (e.g. vertically, along a column), with product depictions 720, 722 placed above and below the focal product depiction 710. The first dimension 712 can group products with one or more shared categories with focal product 710. For the purposes of example, the first dimension 712 depicts product dimensions with three categories associated with them. The categories may be included in a sequence. Using the focal product 1-X-A as an example, the current first axis logic has selected as the first dimension a product having the same product line (“1”, Scuba), a different colour (Z, Green) and the same colour shading (“A”, muted). The second axis logic defines, as a second dimension 714, a product from a different product line (“2”, Swift), with the same colour (“X”, pink), and a different colour shading (“C”, matte). The categories (in this example, three categories were used) represent metadata values associated with the focal product, while the dimension represents a sequence or ordered group of categories which are associated with the focal product through a logical relationship defined by the product dimensions. That is, a dimension can define multiple products that relate to the focal product 710 by a shared category. In this example, product name 924 is displayed in relation to the new dimension of 2-X-C.

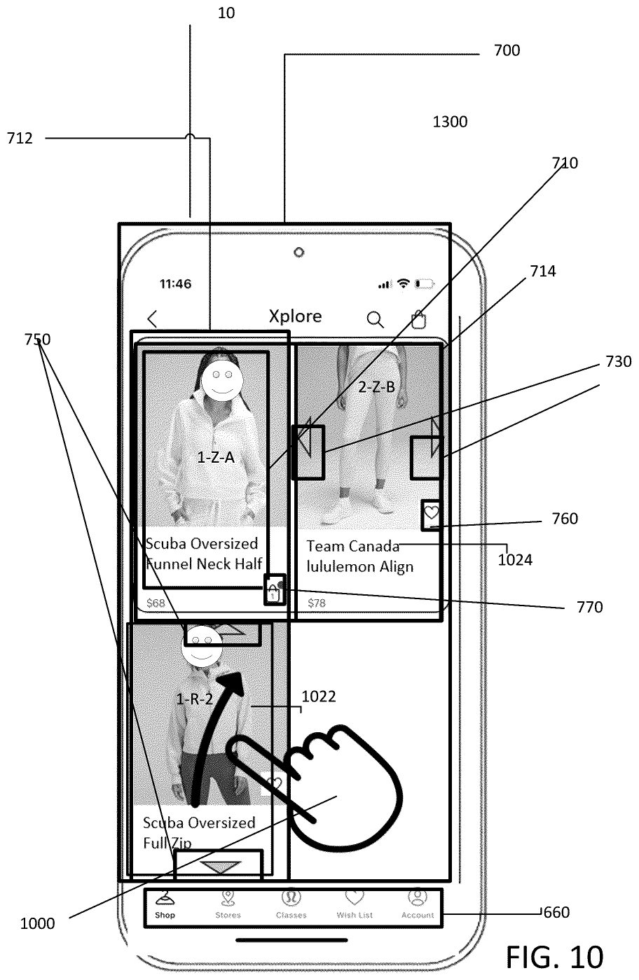

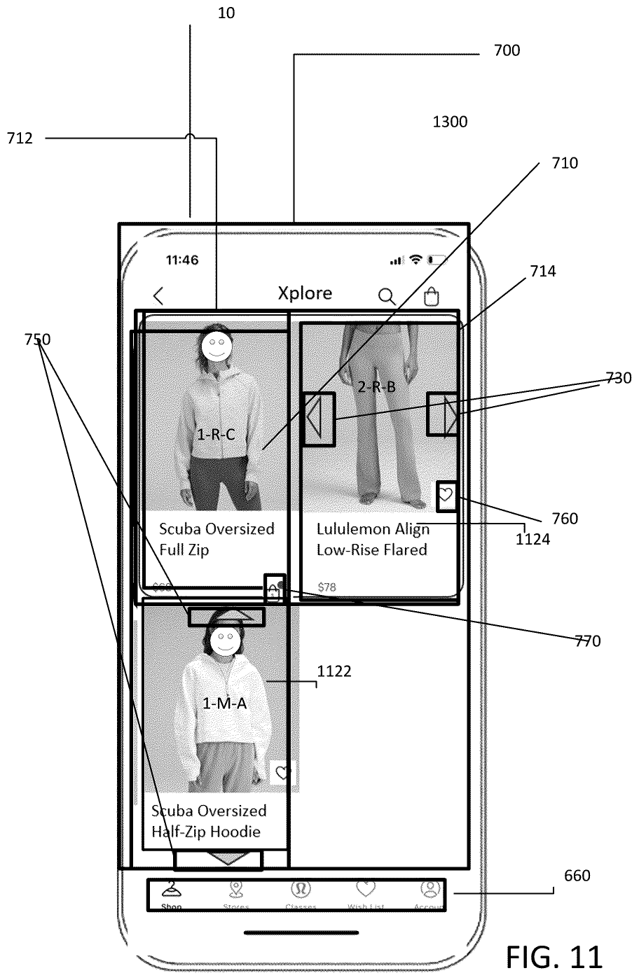

FIG. 10 and FIG. 11 shows an example PDN UI 700 where the user gesture/input 900 and 1000 has caused an update to the focal product. The updated focal product will cause a new set of product dimensions to be calculated based on the categories of the new focal product. In some embodiments, the prioritization and axis logic for the first and second dimension will also be updated.

In FIG. 10, the initial focal product depiction from FIG. 9 has been replaced by a new focal product depiction having product dimension “1-Z-A”. The first and second dimensions from FIG. 9 must be updated since they are no longer associated with the focal product after the update. The updated first and second dimensions are recalculated using a combination of an updated axis logic, updated priority logic, or updated product grouping. In the current example, the first and second axis logic has remained the same, with the first axis depicting products within the same line, having a different colour, and a different shade, and with the second axis depicting products within a different line, having the same colour, and a different shade. While the axis logic has remained the same, the product depictions are updated based on the new focal product and a new order of prioritized depictions for the first and second dimension have been generated by the priority logic. In this example, product name 1024 is displayed in relation to the new dimension of 2-X-C. In this example, product depiction 1022 is displayed in relation to the dimension 1-R-2.

FIG. 11 shows a further iteration of updating the focal product based on user gesture/input 1000. In FIG. 11, the same course of events as FIG. 10 is shown but with a new focal product (1-R-C) being chosen, and the first and second dimensions being updated to reflect the change to the focal product. In this example, product name 1124 is displayed in relation to the dimension of 2-R-B. In this example, product depiction 1122 is displayed in relation to the dimension 1-M-A.

FIGS. 12A-12D shows alternative techniques for displaying a PDN interface associated with embodiments. A number of user interface design principals may be applied to show the relationships between a focal product, or focal set of products.

Turning to FIG. 12A, an interface that depicts three associated product dimensions within a PDN is illustrated. In some embodiments, interface displays and/or otherwise provides more than 3 dimensions associated with a focal product. In FIG. 12A user device 10, displays user interface 1200 wherein focal product 1202 with functionality access component 1204 and product depiction A-$-1 is displayed in relationship to a primary A dimension which also includes elements 1210 (A-$-2, A-$-3) and in relationship to two secondary dimensions 1206 (B-$-1, B-$-2) and 1212 (A-%-1, A-%-2, A-%-3). Each of dimension 1206, 1210 and 1212 have an affiliation with focal product 1204. Focal product controls 1203 provide engagement options to the user to allow them to control the dimension arrangement and format (e.g. format of the visual elements) relative to the focal product. In some embodiments, focal product controls 1203 can include controls such as collapse dimensions, expand dimensions depictions, reduce dimension depictions, add dimensions, arrangement of dimension depictions relative to focal product 1202, or the like. In some embodiments, as a user gestures toward a product depiction along either the first, second or third axis, the product depictions will increase in size to increase engagement. The user gesture can include eye capture technology, a combination of pressing and holding a touch screen, VR/AR gloves, pointing, or the like.

In some embodiments, depictions of dimensions 1206, 1210 and 1212 may consist of multiple product depictions where each product depiction has the same varying dimension characteristic (i.e. for 1206, 1210 and 1212, all product depictions vary by the third dimension characteristic). In another embodiments, each product dimension can vary by a different dimension characteristic (i.e. first dimension varies the first dimension characteristic ( . . . −$−1), second dimension varies the second dimension characteristic (B− . . . −1), etc.).

Turning to FIG. 12B, an interface that depicts two associated product dimensions within a PDN UI is illustrated. In FIG. 12B user device 10, displays user interface 1220 wherein focal product 1222 with functionality access component 1221 and product depiction D-$-2 is displayed in relationship to a primary D dimension 1226 which intersects with E dimension 1228. Functionality access component 1221 provides the user with the ability to interact with the visual element(s) representing the focal product and access further information from the Retail Platform 80. In some embodiments, functionality access component 1221 can include controls such as access cart, access wishlist, expand product details associated with focal product, and the like. In some embodiments, a primary dimension, such as primary D dimension 1226, includes larger product depictions and the secondary dimension, such as secondary E dimension 1228, provides smaller product depictions. A number of approaches to visual logic can be used to direct user attention, facilitate user engagement, direct user interpretation of the relationships between dimensions and direct user interpretation of the relationships between product depictions. In some embodiments, the dimension logic which determines the secondary E dimension may select product dimensions based on factors such as past purchase trends, product dimensions that compliment each other (i.e. if focal product is a shirt, secondary dimension will always be a product that can be worn with the shirt such as shorts or sweater), conversion likelihood, promotions, or the like. In some embodiments, an interface display provide more than 2 dimensions associated with a focal product. In some embodiments, a two dimension PDN is preferred based on user engagement and conversion metrics.

FIG. 12C shows a user interface for an AR/VR environment where the user interface is spatial. In one embodiment, a mixed reality application may be provided in association with a conventional in-person retail environment. User device 10A in this example is a VR headset which is coupled to User device 10B which is a VR glove or other VR output/gesture device. Focal product 1254 will be displayed on the UI directly in front of the user, ideally along the line of sight, in such a manner that the product depiction is larger then the other dimension depictions. First dimension 1258 will be depicted along a first axis which intersects with the focal product 1252 along a plane. The second dimension and third dimension, 1254 and 1256 respectively, will be depicted along a second and third axis which is associated with the focal product 1252. In some embodiments, the focal product 1254, and product depictions that the axis logic would like to prioritize, can be given larger space on the UI and will be grouped closer together. In some embodiments, the user, through user device 10B, can grab certain product depictions and move them closer to the focal product. In some embodiments, the user has full control over the organization of product depictions, including size, orientation and proximity to the focal product.

Turning to FIG. 12D, a user device 10 is shown displaying a PDN UI 6 where the dimensions depictions are combined on a model layout 1262. In some embodiments, product dimensions are selected based off of a focal product 1266 and contain more then one product depictions. First dimension 1295 is a set of product depictions associated with focal product 1264 all being in the “headwear” category. Second dimension 1290 is a set of product depictions all being in the “upper body garments” category. The third dimension 1280 is a set of product depictions all being in the “lower body garment” category. The fourth dimension 1270 is a set of product depictions, including the focal product, all being in the “footwear” category. In this example, sneaker 1260 in the dimension 1270 has been selected as the focal product. The user can update the outfit through input gestures to replace the focal product 1266. In some embodiments, to update the focal product 1266, the user can drag the focal product 1266 symbol (i.e. a start in this example) onto a new item which will then lock that product depiction to the model layout 1262 as the focal product. In some embodiments, by updating the focal product, the first 1295, second 1290, third 1280 and fourth 1270 dimensions will be updated as well.

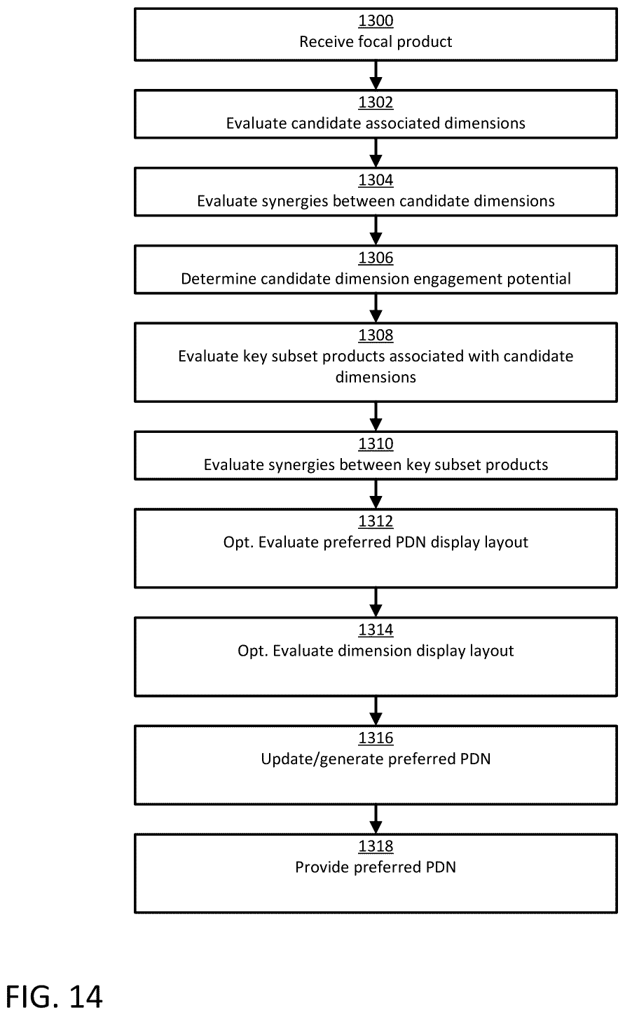

FIG. 14 shows a method for generating a prioritization logic for a dimension. In some embodiments, the priority logic is generated by the PDN/PD 62 and executed by the hardware processor 13. In some embodiments, a default dimension priority logic is applied. In some embodiments, the default dimension priority logic is modified and/or improved based on ML or AI improvements to the PD/PDN model.

Receive focal product 1300 will consist of a data set including the focal product metadata and at least two depictions of the focal product. In some embodiments, the focal product will be generated by the PD/PDN 62 based on an explicit user selection, a previous purchase or wishlist selection, or a prediction using the context and navigation data. In some embodiments, the focal product is more then one product or a group of products. In some embodiments, Receive focal product 1300 will be initiated by a user launching the PD/PDN 62, such as by the example seen in FIG. 6.

Evaluate candidate associated dimensions 1302 comprises logic evaluating, using the categories associated with the focal product, the potential dimensions that could be associated with the focal product. In some embodiments, the associated dimensions will be evaluated based on metrics such as how well they compliment, contrast or match the focal product metadata. As an example, if the focal product is an upper body covering, a dimension having an apparel category dimension of “lower body covering” will be evaluated as a better dimension option then one with an apparel category dimension of “socks”. It should be mentioned that the logic used to Evaluate candidate associated dimensions 1302 will vary based on the category being evaluated, such that a product color category dimension may include logic determining product depictions associated with similar or contrasting, primary color, detail color, complimentary colors, luminance, vibrancy, palette, color family, warmth/coldness, complexity of color combinations, or the like. For the purposes of example, an apparel category dimension could evaluate different criteria than a color category dimension. For example, an apparel category dimension may include logic associated with similar or contrasting features, portion of the body covered, layer, gender intention, cup-size intention, sleeve length, temperature intention, activity intention, or the like.

Evaluate synergies between candidate dimension 1304 comprises assessing the candidate dimension logic to evaluate the interaction between the two or more candidate dimensions and the focal product. Evaluate synergies between candidate dimension 1304 will provide metadata associated with the strength of a synergy between a candidate dimension and the focal product and/or other candidate dimensions to Determine candidate dimension engagement potential 1306. In some embodiments, the strength of a synergy is evaluated based on user input 410, user navigation history, navigation metadata, context input 408, and user data from groups of users having related context and navigational characteristics. In some embodiments, a strong synergy will be found for dimension logic which presents the greatest number of products with the highest conversion probability. For example, if a focal product was a red hiking jacket, a first dimension logic which presented different coloured hiking jackets and a second dimension logic which presented other red hiking apparel (i.e. red pants, red hats, red shirts) would have a stronger synergy then a dimension which showed red jackets that were unrelated to hiking. In the above example, the stronger synergy may be based on the fact that the first and second dimension show a similar or greater amount of products but have a higher conversion likelihood since a user is more likely to select a product within the same activity type. As another example, a first dimension involving a matching activity category of “hiking” with the focal product, and a second dimension involving a matching season category of “cold gear” with the focal product will have a high likelihood of engagement for a user who is interacting with the Retail Platform 80 during the winter season (context data) and has previously purchased hiking clothes (navigational data). In some embodiments, logic that presented the greatest number of products with the highest probability based on current/all user data in resulting in a sale can be used to determine dimensions or groupings. Some products tend to be purchased in combination and the logic may present that set or grouping. The logic can support grouping popular products, promotions, products related to users' wishlists, previous purchase history, preferences, either at an individual, demographic, or regional level.

In some embodiments, a strong synergy will exist for candidate dimensions which include categories of product which tend to be purchased in combination, for example, a candidate dimension being composed of hiking socks will have a high synergy with a focal product or second dimension being composed of hiking shoes. Evaluate synergies between candidate dimension 1304 could provide an output of possible candidate dimensions which can be evaluated at Determine candidate dimension engagement potential 1306. In some embodiments, dimension synergy can be evaluated based on providing the user with two or more dimensions that compliment or contrast with the focal product through different categories. In some embodiments, candidate dimension synergy will be evaluated based on providing dimension logic that supports, e.g., displaying the most popular products, promotions, products related to a users wishlist, previous purchase history, preferences, either at an individual, demographic, or regional level. For example, if candidate dimension 1 has the same colour category as the focal product, then an effective synergy for candidate dimension 2 would be a dimension matching the apparel category of the focal product as this would provide the user with product dimensions that do not overlap. As an example, a low dimension synergy could be a candidate dimension 1 which has a complimentary primary colour category with the focal product and a candidate dimension 2 which has a complimentary colour vibrancy category with the focal product. In some embodiments, determining what constitutes a high dimension synergy can be done by predictive modeling through the ML/AI Module 85 and PD/PDN 62.

Determine candidate dimension engagement potential 1306 comprises logic assessing the likelihood of a candidate dimension leading to a purchase or further engagement with the PDN UI 6. Determine candidate dimension engagement potential 1306 uses the metadata inputs from Evaluate synergies between candidate dimension 1304 to order and prioritize the candidate dimensions or sets of candidate dimensions. In some embodiments, assessing the potential for higher user engagement will be based on past user navigation and context data which will provide insight into what product dimensions or set of product dimensions the user will be likely to engage with.

Evaluate key subset products associated with candidate dimensions 1308 comprises generating a grouping of products matching the candidate dimension characteristics of the candidate dimensions identified in step 1306. Evaluate key subset products associated with candidate dimensions 1308 will output a grouping of products to Evaluate synergies between key subset products 1310 for each candidate dimension.

Evaluate synergies between key subset products 1310 comprises a prioritization logic that will prioritize two or more dimension depictions to display on PDN UI 6 based on an evaluation of the user engagement and conversion likelihood stemming from displaying the dimension depictions together. In some embodiments, this will be determined using product availability, default navigational contexts, user navigational contexts, specific characteristics of the focal product, specific characteristics of the user, user history, user purchases, user demographic, user demographic history, product sales history, product conversion history, access time frame, membership level, region, promotions, user wishlist or the like.

Evaluate preferred PDN display layout 1312 comprises assessing how the focal product and two or more dimension depictions will be displayed on the PDN UI 6 based on the context in which the user is interacting with the User Device 10. In some embodiments, there are several default PDN display layouts used to reduce processing time that are applicable to common online retail environments and product contexts. For example, a User Device 10 consisting of a mobile phone will have a set of default PDN UI 6 displays based on the initial focal product selection chosen. The preferred PDN display layout can include variations to the depiction size, depiction location, font, colour scheme, possible user gesture inputs, level of user engagement with the depictions (i.e. dragging products onto a model), or the like. In some embodiments, Evaluate preferred PDN display layout 1312 will provide different preferred PDN display layouts based on any one of the product category, number of dimensions, key subset products, key subset product synergies, gender, conversion metrics, device capability, online retail environment, promotions, or the like. Evaluate preferred PDN display layout 1312 may be based on dimensions, number of dimensions, key subset products, synergies key subset products, and so on.

Evaluate dimension display layout 1314 comprises determining how to display the dimensions associated with the focal product on the PDN UI 6. In some embodiments, the user can customize the dimension display layout based on their preferences. The display layout will be based on the same metrics used at step 1312, including the product category, number of dimensions, key subset products, key subset product synergies, gender, conversion metrics, device capability, online retail environment, promotions, or the like. As an example, this could take the form of an initial focal product selection being a pair of pants, and the preferred PDN display having any upper body covering products being displayed in column view above the focal product as this would be how the user would wear the two products together. Evaluate dimension display layout 1314 may be based on based on dimensions, number of dimensions, key subset products, synergies key subset products, and so on.

Update/generate preferred PDN 1316 will generate the focal product and dimension depictions for the user based on the prioritization logic and focal product selection. The preferred PDN can be updated based user input and navigational data. In some embodiments, a new focal product may be selected which will require an update to the focal product depiction and dimension depictions.

Provide preferred PDN 1318 displays the preferred PDN to the User Device 10 on PDN UI 6. The preferred PDN can be one of the two dimension depictions provided by Product Model 60 and one or more focal product depictions.

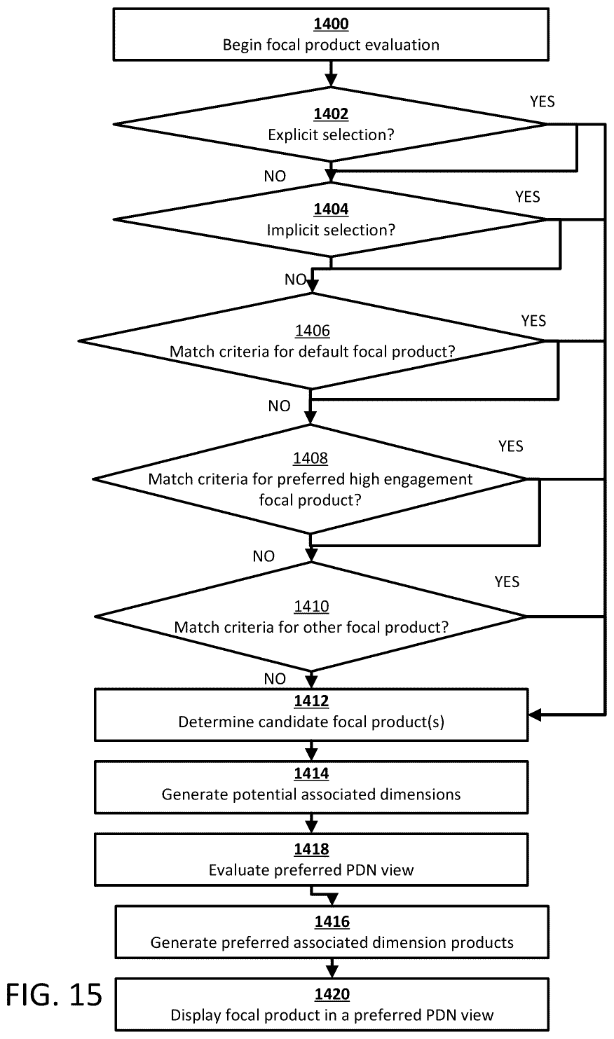

FIG. 15 is a method for focal product evaluation and generation, performed by PDN 62. In some embodiments, focal product represented by a product depiction is generated based on at least one of a product promotion rating, the navigational context associated with a user, a random selection, a random selection within a search, a closest match selection within a search, a random selection within a category, a closest match selection within a category, a random selection within a product category or a closest match selection within a product category, and so on.

Begin focal product evaluation 1400 is initiated by a user interaction with the Retail Platform 80. As an example, Begin focal product evaluation 1400 is initiated in FIG. 6 through a selection of the “explore” function in an online retail environment.

Explicit selection 1402 comprises PDN 62 determining if a user explicitly selected a product depiction. If a user has made an explicit selection, then the method will provide the potential focal product to step 1412, and will then proceed to Implicit selection 1404. If there is no explicit selection, the PDN 62 will check if there was an Implicit selection 1404.

Implicit selection 1404 comprises PDN 62 determining if an implicit selection of a focal product can be determined based on navigational and context metadata. In some embodiments, an implicit selection can be generated based on the user's previous purchase and navigational history, search input, products in the users cart or the user's wishlist. If an implicit selection can be generated by the PDN 62, then the method will provide the potential focal product to step 1412, and will then proceed to Match criteria for default focal product 1406. If there was no implicit selection, then the PDN 62 will check if there is a Match criteria for default focal product 1406.

Match criteria for default focal product 1406 comprises PDN 62 determining default focal product criteria for a user based on the user context and navigational metadata. In some embodiments, Retail Platform 80 will have default focal product criteria for gender, product category, activity category and/or region based on a looser criteria match then used for implicit selection. If default focal product criteria can be generated by the PDN 62, then the method will provide the criteria to 1412, and will then proceed to Match criteria for preferred high engagement focal product 1408. If there was no default focal product criteria, then the PDN 62 can check if there is a Match criteria for preferred high engagement focal product 1408. Applicant 18 may define a default focal criteria for a gender, product category, activity category, region. This may be based on a filter/criteria set than the implicit/explicit selection in some embodiments. By way of example, for an enterprise retail environment, there may be a range of logic that can be used to select which product depiction to prioritize. In some embodiments, a focal product can be depicted based on e.g. search, category selection, or navigation potentially in combination with other forms of product depiction logic (standard banner/grid views, scrollable product lists).

Match criteria for preferred high engagement focal product 1408 comprises PDN 62 determining if the user's context and navigational metadata create a match with any high engagement products that could be used as an initial focal product criteria. In some embodiments, high engagement focal product criteria can include criteria which the user, or past user's having similar context metadata values to the user, have engaged with through the Retail Platform 80. If a match criteria can be generated by the PDN 62, then the method provide the potential focal product to step 1412, and will then proceed to Match criteria for other focal product 1410. If there was no match criteria, then the PDN 62 will check if there is a Match criteria for other focal products 1410.

Match criteria for other focal product 1410 can include PDN 62 performing a final check, prior to finalizing the focal product evaluation, to assess any other potential focal product match criteria that may not have been assessed in the previous steps. For example, other focal product match criteria can include secondary engagement levels, focal product based on user history, items in user wishlist/cart and non-primary high engagement logic. In some embodiments, the match criteria assessed at Match criteria for other focal product 1410 may overlap with the logic used at any of previous steps 1408, 1406 or 1404. In some embodiments, focal product match criteria may be composed of potential product categories which have an association with the user data. In some embodiments, focal product match criteria is logic used to select the potential focal product categories.

Determine candidate focal product(s) 1412 comprises the PDN 62 receiving focal product metadata from steps 1402, 1404, 1406, 1408 and 1408 and identifying a focal product depiction to use as the candidate focal product. Unless a user explicitly selects a focal product at step 1402, the PDN 62 may be given focal product metadata with multiple depictions and will have to determine a preferred focal product. For example, if Implicit selection 1404 provides focal product metadata, then there may be multiple colour, size and style variants associated with the focal product metadata, with each variant having its own product dimensions and depiction. In some embodiments, a candidate focal product can be selected using general retail selection criteria such as promotion, conversion probability, size, gender, regional availability, season, user purchase history, navigational history, search inputs, category selections, or the like. In some embodiments, a candidate focal product depiction will be selected using general retail selection criteria along with secondary product depiction logic relating to how the product will be displayed such as standard banner view, grid view or scrollable product lists. In some embodiments, the PDN 62 will always prioritize the focal product metadata provided through Explicit selection 1402. In some embodiments, a candidate focal product can be more then one product or a set of products.

Generate potential associated dimensions 1414 comprises the PDN 62 identifying potential dimensions which are associated with the focal product, such that two or more metadata characteristics of the focal product match, complement or contrast the dimension characteristics. In some embodiments, the dimensions characteristics can be a product characteristic, taxonomy, or combination of both.

Evaluate preferred PDN view 1418 will use potential dimensions identified at Generate potential associated dimensions 1414 and the focal product metadata identified at Determine candidate focal product(s) 1412 to prioritize two or more dimension depictions. The associated dimensions are used to create groupings of products which match the axis logic associated with the dimensions. The PDN 62 will use the priority logic on the groupings of products to create a display order, within each grouping, of products based on the focal product selected. Evaluate preferred PDN view 1418 will also determine which dimension depiction will be used based on the two depictions provided by Product Model 60.

In some embodiments, the prioritization logic will include assessing product metadata availability, default navigational contexts, user navigational contexts, specific characteristics of the focal product, specific characteristics of the user, user history, user purchases, user demographic, user demographic history, product sales history, product conversion history, access time frame, membership level, region, promotions, user wishlist or the like.

Generate preferred associated dimension products 1416 comprises using prioritization logic to select two or more dimension depictions to display to the user alongside the focal product. The two or more dimension depictions will be displayed on two or more axis, with at least the one axis being associated with the focal product.

Display focal product in a preferred PDN view 1420 comprises a depiction of the focal product being displayed on the User Device 10. In some embodiments the preferred PDN view will vary depending on the User Device 10 display size, User Device 10 capabilities, online retail context and focal product. In some embodiments, the focal product can be displayed on an interactive model, as a video, with an audio file, as an augmented reality display, multiple poses/models, or the like.

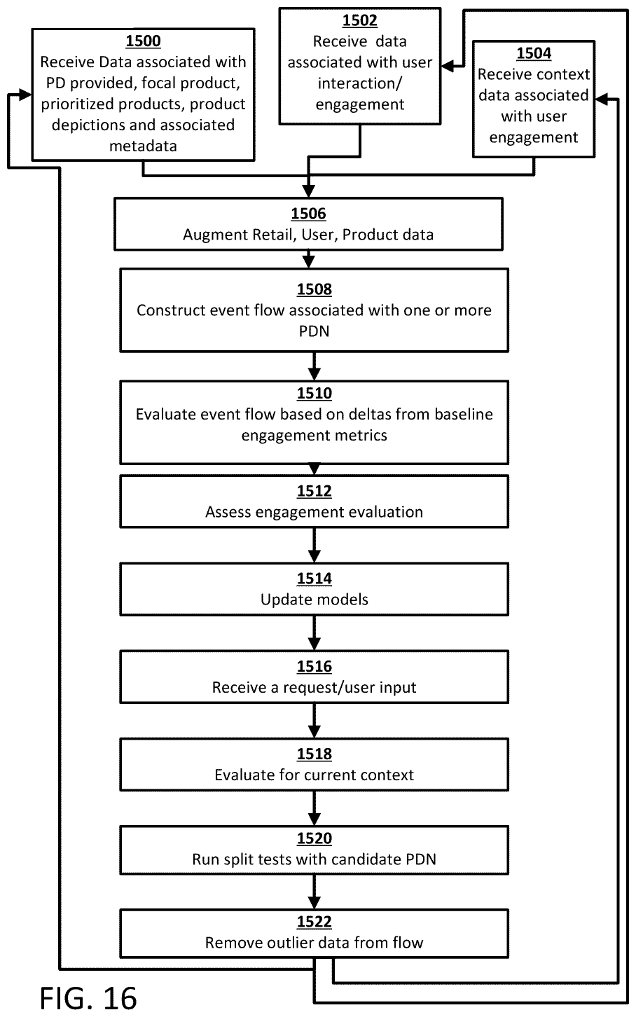

FIG. 16 is an example method to use AI/ML Model 85 to refresh the Product Model 60, PD/PDN 62, Context 65, User 70 and Gesture 75 and improve the selection of product dimensions associated with a focal product, specific depiction of the focal product when there is more than one available and prioritization logic used to select products or product depictions within the dimensions.

Receive Data associated with PD provided 1500 comprises receiving, using at least one hardware processor 13, a set of data defining a product dimension, or a set of product dimensions wherein the data associated with PD can include focal product metadata, product data for prioritized products within a grouping of products, focal product depictions, dimension depictions, or any product metadata associated with a product dimension.

Receive data associated with user 1502 comprises receiving, using at least one hardware processor 13, a set of data defining a user identity wherein the data can include a token, ID, machine executable code, user authentication details, device metadata, location, activity or class associated with the user, activity type, class type, date, time, region, local weather and other regional factors, user device hardware details, system details, membership level details, user points or rating, user activity history, user purchase history, user navigational history, user preferences, file encryption standards, music, audio, lighting conditions, a combination thereof, and the like. In some embodiments, metadata related to the user may be retrieved from user model 70, context 65, gesture 75, retail platform 80, retail model 811, user device metadata 16 and the like based on an ID provided. In some embodiments, the user is provided with a method, such as a user interface (UI) in application 18 or navigational system in retail platform 80 in which they may select a product category, product characteristic, focal product and/or provide additional context information. In some embodiments, user data includes data related to other users of PDN system. In some embodiments, user data includes historical data associated with users and/or user navigation. In some embodiments, depersonalized data is provided.

Receive context data 1504 comprises receiving, using at least one hardware processor 13, a set of data defining a user identity and the manner in which the user is engaging with the Retail Platform 80 wherein the data can include the user navigation history such as identifying qualities such as retail purchases, navigation conversion, activity history, wishlist, content, wishlist history, cart content, cart history appropriate to PDN generation and/or evaluating engagement with PDN. In some embodiments, context data includes data relating to the manner in which the user is interacting with the PDN, such as through an online digital retail environment, participating within a smart mirror based activity (exercise class, training session, concert), a workout or wellness activity performed by an individual, a virtual reality context, a wellness recommendation system, an online social media environment, a retail environment, and/or using an application specifically for evaluating products and providing information about more than one product dimension. In some embodiments, input device 15 provides one or more elements of the context data.

Augment Retail, User, Product data 1506 comprises receiving the original sets of data from Receive Data associated with PD provided 1500, Receive data associated with user 1502 and Receive context data 1504, and increasing the size and diversity of the training data by modifying the original data provided to create new sets of data. The augmented data will be used to train the ML/AI Model 85 and avoid overfitting.

Construct event flow associated with one or more PDN 1508 comprises creating an event-driven process chain in which the generation of a PDN, using the augmented retail, user and product data received from step 1506, is mapped through an ordered flow of events and functions. Functions represent an action which receives a set of data (initial state), and outputs metadata or a signal (resulting state) representing a logical transformation. For example, the event flow may have a function that receives product data, and outputs product metadata such as color, product type, logo type, logo placement, gender intention, pattern, size, fit, activity, and other characteristics. Events represent either an initial state in which a function operates or the results from a function. For example, the event flow may have an event in which more then two dimension depictions will be provided only when the context data indicates that the retail context is an AR/VR retail environment.

Evaluate event flow based on deltas from baseline 1510 comprises evaluating the results of the event flow using the augmented data compared to the baseline PDN. The PDN generated by the event flow using the augmented data will be compared to the baseline result based on user engagement metrics.

Assess engagement evaluation 1512 comprises using the results from the testing performed in step 1510 to assess user engagement metrics such as user navigation, user purchase and user interaction with the platform.

Update models 1514 comprises the ML/AI Model 85 updating the Model 60, PD/PDN 62, Context 65, User 70 and Gesture 75 to optimize the user interaction with product depictions within product dimensions, product dimensions, product dimension logic, priority logic/axis logic, product dimension controls. In some embodiments, ML/AI Model 85 will update the processor executable instructions and processor-readable data stored within the models such that the updated data and instructions are optimized towards increasing user engagement.

Receive a request/user input 1516 comprises Gesture 75 and User 70 receiving a user gesture or input through the User Device 10, and providing ML/AI Model 85 with a user input which will be used to update the logic used to generate the PDN, or set of PDN, to respond to the user input data communicated through the gesture or input. In some embodiments, the ML/AI model 85 will update the logic of the overall dimension, combination of dimensions, and prioritized product depictions associated with one or more dimensions to reflect implicit search criteria reflected in the user input. In some embodiments, user input can be a gesture, other navigational input, sensor data or electrical signals, for example. The input data can be captured in real-time or near real-time.

Evaluate for current context 1518 comprises the ML/AI Model 85 determining the current context in which the user is interacting with the PDN based on the user input received at step 1516. In some embodiments, the current context will be determined using updated data corresponding to user inputs relating to retail purchases, navigation conversion, activity history, wishlist, content, wishlist history, cart content, cart history appropriate to PDN generation and/or evaluating engagement with PDN.

Run split tests with candidate PDN 1520 comprises splitting the set of data received from steps 1516 and 1518 into two subsets, with one subset being used for training the ML/AI Model 85 and the second subset being used to evaluate the fit of the ML/AI Model 85. The first subset of data will be used to train the ML/AI Model 85 to generate a PDN. The second set of data will be used to test the ML/AI Model 85 prediction compared to the candidate PDN selected through the method in FIG. 15. In some embodiments, the split of data between the two subsets can be 80% training-20% testing, 67% training-33% testing, 50% training-50% testing.

Remove outlier data from flow 1522 comprises using the results from the fit test done in Run split tests with candidate PDN 1520 to remove outlier data in the augmented data set. In some embodiments, outlier data will represent a PDN or subset of PDN which was provided by the ML/AI Model 85 which are unlikely given the set of data provided. In some embodiments, removing outlier data can be done through standard deviation method, interquartile range method, automatic outlier detection, baseline model performance, isolation forest or minimum covariance determinant. After the outlier data has been removed, the hardware processor will initiate steps 1500, 1502, and 1504 again to receive further sets of data related to the user.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

The technical solution of embodiments may be in the form of a software product. The software product may be stored in a non-volatile or non-transitory storage medium. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A computer implemented method for selectively updating a visual display and providing output instructions for product navigation in response to one or more user gestures, the method comprising:
receiving, using at least one hardware processor, a set of product data defining more than one product;
wherein in the set of product data, a set of elements associated with the product provide,
a product depiction associated with the product;
two metadata values, wherein the first metadata value comprises one of a value associated with a product taxonomy, a product characteristic, a combination of the product taxonomy and the product characteristic associated with the product, and wherein the second metadata value comprises one of a value associated with a product taxonomy, a product characteristic, a combination of the product taxonomy and the product characteristic associated with the product;
associating, using at least one hardware processor, the first metadata value associated with the product of a first category and a second metadata value associated with the product of a second category;
categorizing, using at least one hardware processor, a first grouping of products, represented by product depictions, associated with the first category, and a second grouping of products, represented by product depictions, associated with the second category wherein the first grouping is associated with one or more sets of first axis logic associated with the first category and the second grouping is associated with one or more set of second axis logic associated with the second category;
receiving, using at least one hardware processor, a context input;
receiving, using at least one hardware processor a focal product represented by a product depiction;
calculating, based on one or more of the focal product, the context input, the first grouping of products and the second grouping of products, using at least one hardware processor, an initial subset of product depictions to display on a first axis and a second axis wherein the focal product is associated with the first axis logic and the second axis logic;
displaying, on a visual display of a user device, a user interface wherein a portion of the user interface comprises a subset of product depictions in the first grouping of products along the first axis, wherein the focal product is represented by a product depiction in the first axis, and wherein another portion of the user interface comprises a subset of product depictions in the second grouping of products along the second axis wherein the subset of product depictions in the second grouping are associated with the initial focal product;
transmitting control signals to one or more sensors to perform measurements;
receiving, using the at least one hardware processor and the one or more sensors, input data that comprises data characterizing a user gesture from the measurements;
evaluating, using the at least one hardware processor, the input data characterizing the user gesture in relationship to the first axis logic and the second axis logic;
selectively and automatically updating, at the visual display of the user device, the user interface, based on the input data characterizing the user gesture, wherein selectively and automatically updating includes one of updating in the user interface a product depiction representing the focal product to a next focal product depiction and updating one or more of the subset of product depictions in the first grouping along the first axis, the subset of product depictions in the second grouping along the second axis, both the subset of product depictions in the first grouping along the first axis and the subset of product depictions in the second grouping along the second axis, updating the subset of product depictions in the second grouping along the second axis.

2. The method of claim 1 comprising depicting the first axis vertically and depicting the second axis horizontally.

3. The method of claim 1 further comprising receiving a third metadata value, third category, a third grouping, and a subset of products associated with the third grouping and displaying and updating a third axis.

4. The method of claim 1 or 3 wherein the first axis logic is associated with a first dimension representing a logical association between the focal product and the first category, and wherein the second axis logic is associated with a second dimension representing a logical association between the focal product and the second category.

5. The method of claim 4 wherein the logical association is one of a category match, contrasting category or complimentary category.

6. The method of claim 1 further comprising calculating, based on the context input, first grouping of products and second grouping of products using at least one hardware processor an initial focal product represented by a product depiction;
wherein the product depiction is one or more of a photograph, rendering, video clip, simulation, preview, thumbnails, audio file, interactive media, AI generated media, and/or a combination, and
wherein the product depiction is represented by an identifier, link, or combination.

7. The method of claim 1 wherein the one or more sensors to perform measurements comprise a touch screen.

8. The method of claim 1 further comprising modifying the second category logic based on the metadata associated with the first and/or next focal product.

9. The method of claim 1 wherein the user interface is one of a Graphical User Interface (GUI), Tangible User Interface (TUI) Natural User Interface (NUI), Augmented Reality (AR), Virtual Reality (VR), Mixed Reality, or combination.

10. The method of claim 1 wherein receiving using at least one hardware processor the focal product represented by the product depiction further comprises receiving instructions to determine a focal product based on at least one of a product promotion rating, the navigational context associated with a user, a random selection, a random selection within a search, a closest match selection within a search, a random selection within a category, a closest match selection within a category, a random selection within a product category or a closest match selection within a product category.

11. The method of claim 1 wherein the first category is associated with a product designed for covering a first portion of a wearer's body and the second category is associated with a product designed for a second portion of a wearer's body, wherein the first category is a first apparel category and wherein the second category is a second apparel category, and/or wherein the first and/or second category is associated with a color logic.

12. The method of claim 1 further comprising, using a model layout to display a multi-dimensional depiction of the product depiction representing the focal product and the subset of the product depictions as an outfit or arrangement.

13. The method of claim 1 comprising updating the visual display by visually highlighting the focal product over the non-focal products through one or more of the location in user interface, size, outline, visual indicators, color and/or color intensity, background color, visual flags or usage of a depiction format such as video or live photo.

14. A processing system for selectively updating a visual display, the processing system having one or more processors and one or more memories coupled with the one or more processors, the processing system configured to cause a visual display to provide visual elements for a retail navigation environment at a user interface of the visual display, wherein a focal product and associated groups of product depictions at the visual display selectively and automatically update in response to one or more user gestures, the system comprising:
a communication interface to transmit a product depiction graphic user interface representation;
one or more non-transitory memory storing a product model;
wherein in the product model comprises a set of product data with elements associated with a product comprising:
a product depiction associated with the product;
two metadata values wherein the first metadata value comprises one of a value associated with a product taxonomy, a product characteristic, a combination of product taxonomy and product characteristic associated with the product and the second metadata value comprises one of a value associated with a product taxonomy, a product characteristic, a combination of product taxonomy and product characteristic associated with the product;
an association between the first metadata value associated with a product with a first category and a second metadata value associated with the product with a second category;
a logical association between the first category and the second category;
a hardware processor programmed with executable instructions for generating visual elements of a product dimension navigation representation for a user interface of a visual display, wherein the hardware processor:
transmits control signals to one or more sensors to perform measurements;
receives from the one or more sensors input data that comprises data characterizing a user gesture;
generates the product dimension navigation representation based at least in part on the input data characterizing the user gesture and product dimensions;
a user device comprising a hardware processor, a visual display and an interface to receive the product dimension navigation representation; and activate, trigger, or present the product dimension navigation representation at the visual display or a user device output.

15. The computer system of claim 14 wherein the product dimension navigation representation comprises horizontal and vertical grids grouping products depictions based on axis logic and the product dimensions.

16. The computer system of claim 14 wherein the user device is one or more of a smart mirror, smart phone, computer, tablet, touchscreen kiosk, smart exercise device, fitness tracker, connected fitness system.

17. The computer system of claim 14 wherein the one or more sensors to perform measurements comprise a touch screen, a body motion detection sensor, a hand motion detection sensor, an arm motion detection sensor, a component within a connected smart exercise system, a computer, a tablet, a smart phone, a smart mirror, a smart mat, a smart watch, a smart sensor, a virtual reality headset, an augmented reality headset, a haptic glove, a haptic garment, a game controller, a hologram projection system, an autostereoscopic projection system, mixed reality devices, virtual reality devices, an augmented reality device, a metaverse headset, which may or may not be integrated in other devices.

18. The computer system of claim 14 further comprising the one or more sensors to perform measurements to receive the input data.

19. The computer system of claim 14 wherein the one or more of the sensors is one or more of a resistive touchscreen, a capacitive touchscreen. a SAW (Surface Acoustic Wave) touchscreen, a infrared touchscreen, a optical imaging touchscreen, a Acoustic Pulse Recognition touchscreen.

20. The computer system of claim 14 further comprising a machine learning component with one or more machine learning models and/or an artificial intelligence component with one or more artificial intelligence models.
